(19) United States
(12) Patent Application Publication
(10) Pub. No.: US 2026/0064772 A1
(43) Pub. Date: Mar. 5, 2026

(54) SMART FRAME SELECTION VIA ACTIVITY-BASED RANKING AND OPTIMIZATION

(71) Applicant: NVIDIA Corporation, Santa Clara, CA (US)

(72) Inventors: Shaunak Gupte, Pune (IN); Tushar Khinvasara, Pune (IN); Swapnil Jagdish Rathi, Pune (IN); Amit Kale, Pune (IN); Bhushan Rupde, Pune (IN)

(73) Assignee: NVIDIA Corporation, Santa Clara, CA (US)

(21) Appl. No.: 18/819,643

(22) Filed: Aug. 29, 2024

(51) Int. Cl. G06F 16/738; G06F 16/783

(52) U.S. Cl. CPC G06F 16/739; G06F 16/786

(57) ABSTRACT

Various examples, systems, and methods are disclosed relating to frame selection via activity-based ranking and optimization. A first computing system can receive a plurality of frames and metadata from a capture device capturing a video stream. The first computing system can generate, using a ranking model, a plurality of rankings for the plurality of frames based on a plurality of video parameters of the plurality of frames and the metadata, wherein the plurality of rankings correspond to a summarization of the video stream. The first computing system can determine at least one of the plurality of frames to provide to at least one buffer based on the plurality of rankings, wherein the at least one buffer stores a subset of frames of the plurality of frames. The first computing system can provide, from the at least one buffer, the subset of frames as input to a machine-learning model.

### BACKGROUND

Video language models (VLMs) are machine learning models that integrate video analysis with natural language understanding and generation. VLMs are trained/updated to interpret video content and generate corresponding output, which can include text descriptions or other generative content. However, existing solutions for executing VLMs require specialized computer hardware or fail to capture all relevant information in video data.

### SUMMARY

Video language models can be trained and/or updated using large corpuses of video information. When providing video data as input to video language models, processing every frame of a video is impractical due to the significant computational and memory demands involved. Videos often include 24 to 60 frames per second, making it unfeasible to process each frame directly in most use cases. To reduce the data volume for processing by the video language model during execution, frames are typically sampled from the video stream. Conventional approaches to frame sampling often rely on selecting frames at predetermined time intervals. However, these methods do not account for the content within the frames, leading to the potential omission of frames containing important information for the processing objective.

To address the limitations of conventional approaches, the systems and methods described herein implement a ranking and management system for video frames based on the content and metadata of the frames. Frames of the video stream can be ranked according to video parameters, such as motion vectors, IDR frames, scene changes, bitrate variations, and optical flow motion vectors, as well as metadata associated with the frames. The ranking process utilizes machine-learning models to assign a numerical rank to each frame, prioritizing frames that are most relevant to the processing objective. This ranking allows for the selection of frames that represent the significant events or actions within the video stream.

The ranked frames can then be managed by a frame manager, which selects and stores the highest-ranked frames in a buffer for further processing by the video language model. By retaining frames with higher rankings, this method uses relevant and informative frames as input to the model, rather than sampling frames based solely on time intervals. The techniques described herein improve upon conventional methods by improving the selection and processing of video frames, thereby enhancing the efficiency and effectiveness of video language models.

Some implementation relates to one or more processors including one or more circuits. The one or more circuits are to receive a plurality of frames and metadata from a capture device capturing a video stream. The one or more circuits are to generate, using a ranking model, a plurality of rankings for the plurality of frames based on a plurality of video parameters of the plurality of frames and the metadata of the video stream, wherein the plurality of rankings correspond to a summarization of the video stream. The one or more circuits are to determine at least one of the plurality of frames to provide to at least one first buffer based on the plurality of rankings, wherein the at least one first buffer stores a first subset of frames of the plurality of frames. The one or more circuits are to provide, from the at least one first buffer, the first subset of frames as input to a first machine-learning model.

In some implementations, the one or more circuits are to determine a second subset of frames of the first subset of frames based on metadata of the first subset of frames and update the at least one first buffer based on the second subset of frames. In some implementations, the one or more circuits are to receive a query regarding content of the video stream and generate, using the first machine-learning model, an output based on the first subset of frames, the output including a response to the query extracting video content of the video stream, wherein the first subset of frames represent the summarization of the video stream. In some implementations, the one or more circuits are to, in response to receiving the query, determine a third subset of frames to apply to the first machine-learning model to generate the output based on detecting, using a second machine-learning model, one or more actions, objects, or movements described in the query.

In some implementations, the summarization represented in the plurality of rankings correspond to the determination of the first subset of frames representing one or more temporal or spatial segments of the video stream. In some implementations, generating, using the ranking model, the plurality of rankings further includes applying differential weighting to the plurality of video parameters. In some implementations, at least one first video parameter is assigned a higher weight according to the ranking model than at least one second video parameter based on the metadata of the plurality of frames.

In some implementations, the one or more circuits are to receive an encoded bitstream of the video stream and decode the encoded bitstream to extract the plurality of frames, the plurality of video parameters, and the metadata of the video stream. In some implementations, the plurality of video parameters include at least one of one or more motion vectors obtained from the encoded bitstream, the one or more motion vectors corresponding to movement data of one or more objects in the plurality of frames, instantaneous decoder refresh (IDR) frames or scene change indicators obtained from the encoded bitstream, the IDR frames or scene change indicators corresponding to content updates in the plurality of frames, one or more bitrate variations obtained from the encoded bitstream, the one or more bitrate variations corresponding to data rate updates used to encode the video stream, or one or more optical flow motion vectors obtained from the encoded bitstream, the one or more optical flow motion vectors corresponding to movement data of one or more objects in consecutive frames of the plurality of frames.

In some implementations, generating the plurality of rankings is further based on using one or more custom computer vision (CV) models to perform at least one of detecting one or more actions or movements within the plurality of frames to increase an efficiency metric of the ranking model, detecting and tracking one or more objects within the plurality of frames to generate the plurality of rankings using the ranking model further based on prioritizing a first type of object of the one or more objects over a second type of object of the one or more objects, or identifying one or more areas of the plurality of frames to detect activity to generate the plurality of rankings using the ranking model further based on prioritizing a first area of the plurality of frames over a second area of the plurality of frames. In some implementations, the metadata of video stream includes text data of the video stream and of text data of content within the plurality of frames, the text data of the video stream and of the content includes at least a type of video and an event type being videoed.

In some implementations, the first subset of frames is further determined based on a plurality of similarity metrics of the plurality of frames, wherein the plurality of similarity metrics are determined using at least one of (i) a cosine distance, (ii) a Siamese network, (iii) a structural similarity, or (iv) background subtraction. In some implementations, the first subset of frames is further determined based on a minimum distance metric between the plurality of frames. In some implementations, the one or more circuits are to maintain the at least one first buffer containing a predetermined maximum number of frames based on the plurality of rankings.

In some implementations, the one or more circuits are to store a plurality of non-selected frames from the plurality of frames in at least one second buffer and transfer at least one of the plurality of non-selected frames in the at least one second buffer to the at least one first buffer responsive to an update to the predetermined maximum number of frames or a detected relevance of at least one of the plurality of non-selected frames. In some implementations, the video stream is at least one of a live stream or an offline stream stored in a file. In some implementations, the one or more circuits are to configure the at least one first buffer for the live stream or the offline stream to perform frame storage.

In some implementations, the at least one first buffer is configured to perform at least one of (i) a circularity process on the first subset of frames stored in the at least one first buffer, (ii) segmenting of the video stream into one or more segments including a fourth subset of frames of the plurality of frames based on at least one segmentation parameter, or (iii) storing a fifth subset of frames of the plurality of frames from a previous segment of the one or more segments and updating the fifth subset of frames based on an updating parameter.

Some implementations relate to a system, including one or more processors to execute operations. The one or more processors can execute operations to receive a plurality of frames and metadata from a capture device capturing a video stream. The one or more processors can execute operations to generate, using a ranking model, a plurality of rankings for the plurality of frames based on a plurality of video parameters of the plurality of frames and the metadata of the video stream, wherein the plurality of rankings correspond to a summarization of the video stream. The one or more processors can execute operations to determine at least one of the plurality of frames to provide to at least one first buffer based on the plurality of rankings, wherein the at least one first buffer stores a first subset of frames of the plurality of frames. The one or more processors can execute operations to provide, from the at least one first buffer, the first subset of frames as input to a first machine-learning model.

In some implementations, the one or more processors executing the operations are to determine a second subset of frames of the first subset of frames based on metadata of the first subset of frames and update the at least one first buffer based on the second subset of frames. In some implementations, the one or more processors executing the operations are to receive a query regarding content of the video stream and generate, using the first machine-learning model, an output based on the first subset of frames, the output including a response to the query extracting video content of the video stream, wherein the first subset of frames represent the summarization of the video stream. In some implementations, the one or more processors executing the operations are to, in response to receiving the query, determine a third subset of frames to apply to the first machine-learning model to generate the output based on detecting, using a second machine-learning model, one or more actions, objects, or movements described in the query.

In some implementations, the summarization represented in the plurality of rankings correspond to the determination of the first subset of frames representing one or more temporal or spatial segments of the video stream. In some implementations, generating, using the ranking model, the plurality of rankings further includes applying differential weighting to the plurality of video parameters. In some implementations, at least one first video parameter is assigned a higher weight according to the ranking model than at least one second video parameter based on the metadata of the plurality of frames.

In some implementations, the one or more processors executing the operations are to receive an encoded bitstream of the video stream. In some implementations, the one or more processors executing the operations are to decode the encoded bitstream to extract the plurality of frames, the plurality of video parameters, and the metadata of the video stream. In some implementations, the plurality of video parameters include at least one of one or more motion vectors obtained from the encoded bitstream, the one or more motion vectors corresponding to movement data of one or more objects in the plurality of frames, instantaneous decoder refresh (IDR) frames or scene change indicators obtained from the encoded bitstream, the IDR frames or scene change indicators corresponding to content updates in the plurality of frames, one or more bitrate variations obtained from the encoded bitstream, the one or more bitrate variations corresponding to data rate updates used to encode the video stream, or one or more optical flow motion vectors obtained from the encoded bitstream, the one or more optical flow motion vectors corresponding to movement data of one or more objects in consecutive frames of the plurality of frames.

Some implementations relate to a method. The method can include receiving, using one or more processors, a plurality of frames and metadata from a capture device capturing a video stream. The method can include generating, using the one or more processors performing a ranking model, a plurality of rankings for the plurality of frames based on a plurality of video parameters of the plurality of frames and the metadata of the video stream, wherein the plurality of rankings correspond to a summarization of the video stream. The method can include determining, using the one or more processors, at least one of the plurality of frames to provide to at least one first buffer based on the plurality of rankings, wherein the at least one first buffer stores a first subset of frames of the plurality of frames. The method can include providing, using the one or more processors from the at least one first buffer, the first subset of frames as input to a first machine-learning model.

The processors, systems, and/or methods described herein can be implemented by or included in at least one a system. The system can include a perception system for an autonomous or semi-autonomous machine. The system can include a system implemented using a robot. The system can include an aerial system. The system can include a medical system. The system can include a boating system. The system can include a smart area monitoring system. The system can include a system for performing deep learning operations. The system can a system for performing simulation operations. The system can include a system for generating or presenting virtual reality (VR) content, augmented reality (AR) content, or mixed reality (MR) content. The system can include a system for performing digital twin operations. The system can include a system implemented using an edge device. The system can include a system incorporating one or more virtual machines (VMs). The system can include a system for generating synthetic data. The system can be implemented at least partially in a data center. The system can a system for performing conversational artificial intelligence (AI) operations. The system can include a system for performing generative AI operations. The system can include a system implementing language models. The system can include a system implementing vision language models (VLMs). The system can include a system implementing large language models (LLMs). The system can include a system implementing multi-modal language models. The system can include a system for hosting one or more real-time streaming applications. The system can include a system for performing light transport simulation. The system can include a system for performing collaborative content creation for 3D assets. In an aspect, the system can be implemented at least partially using cloud computing resources.

### BRIEF DESCRIPTION OF THE DRAWINGS

The present systems and methods for smart frame selection via activity-based ranking and optimization is described in detail below with reference to the attached drawing figures, wherein:

FIG. 1 is a block diagram of an example system for implementing video stream generation for generative artificial intelligence systems, in accordance with some implementations of the present disclosure;

FIG. 2A depicts a dataflow diagram showing how frames are sampled for training and/or updating machine-learning models, in accordance with some implementations of the present disclosure;

FIG. 2B depicts another dataflow diagram showing how frames are sampled for training and/or updating machine-learning models, in accordance with some implementations of the present disclosure;

FIG. 3 is a flow diagram of an example of a method for implementing video stream generation for generative artificial intelligence systems, in accordance with some implementations of the present disclosure;

FIG. 4A is a block diagram of an example generative language model system suitable for use in implementing at least some implementations of the present disclosure;

FIG. 4B is a block diagram of an example generative language model that includes a transformer encoder-decoder suitable for use in implementing at least some implementations of the present disclosure;

FIG. 4C is a block diagram of an example generative language model that includes a decoder-only transformer architecture suitable for use in implementing at least some implementations of the present disclosure;

FIG. 5 is a block diagram of an example computing device suitable for use in implementing at least some implementations of the present disclosure; and

FIG. 6 is a block diagram of an example data center suitable for use in implementing at least some implementations of the present disclosure.

### DETAILED DESCRIPTION

This disclosure relates to systems and methods for smart frame selection for video language models (VLMs), utilizing improved implementations that select frames based on activity and relevance to improve information extraction from videos. For example, systems and methods in accordance with the present disclosure facilitate the analysis of video frames by ranking them based on their content, which can be used to optimize the input provided to VLMs.

Some techniques for frame selection in video analysis rely on fixed-interval sampling, which often results in redundant information and misses important activities or content, leading to inefficient processing and suboptimal analysis. These techniques can fail to provide high-quality insights, as they do not adapt to the varying levels of activity and relevance in the video content. The limitations relate to how these methods handle frame relevance, activity detection, and efficiency. For example, fixed-interval sampling can lead to the selection of similar frames while missing significant events occurring in non-selected frames, resulting in a loss of crucial information and analysis accuracy. Additionally, inadequate frame selection methods can prevent effective processing within limited computational resources, leading to inefficiencies in video analysis tasks.

Systems and methods in accordance with the present disclosure can improve accuracy and efficiency in video frame selection by using an activity-conditioned sampling technique. For example, a plurality of frames can be ranked and selected based on their activity levels, metadata, and/or relevance to the video content, using parameters such as, but not limited to, motion vectors, scene changes, bitrate variations, and optical flow motion vectors. These parameters can represent the dynamic features of the video content with high relevance and importance.

In some implementations, a plurality of frames can be evaluated from a video stream to determine their activity levels and relevance. A ranking model can be used to generate a ranking for each frame based on video parameters and/or metadata. In some implementations, the highest-ranked frames can be selected and stored in a buffer for further analysis. The parameters of the ranking model can be updated based on the activity detected in the frames, such as by determining a relevance score based on the video parameters and/or metadata of the video stream. The selected frames can be used to perform analysis, facilitating the input of accurate and relevant data to the VLMs.

In some implementations, the attributes of the frames can be refined using lightweight models that provide activity detection. This can be performed for attributes such as action recognition, object detection, and activity detection in regions of interest (ROI). The attributes can be adjusted based on inputs such as scene changes and motion vectors, facilitating selection of frames with high relevance and activity levels.

The frame selection method can be used to optimize the input provided to VLMs in various manners. For example, an analysis of the video content can be extracted from the selected frames, and can be processed to meet performance criteria, such as for real-time video analysis applications. Various objectives can be used to facilitate efficient and relevant frame selection, such as to optimize the frame selection for accuracy and computational efficiency.

The systems and methods described herein can be used for a variety of purposes, including but not limited to, enhancing video understanding, improving video summarization, creating detailed video analysis, and in the development of real-time video processing applications. Moreover, these methods can improve the efficiency of video analysis tasks, such as surveillance, sports analytics, content-based video retrieval, industrial inspection (e.g., manufacturing), healthcare analytics (e.g., medical vision).

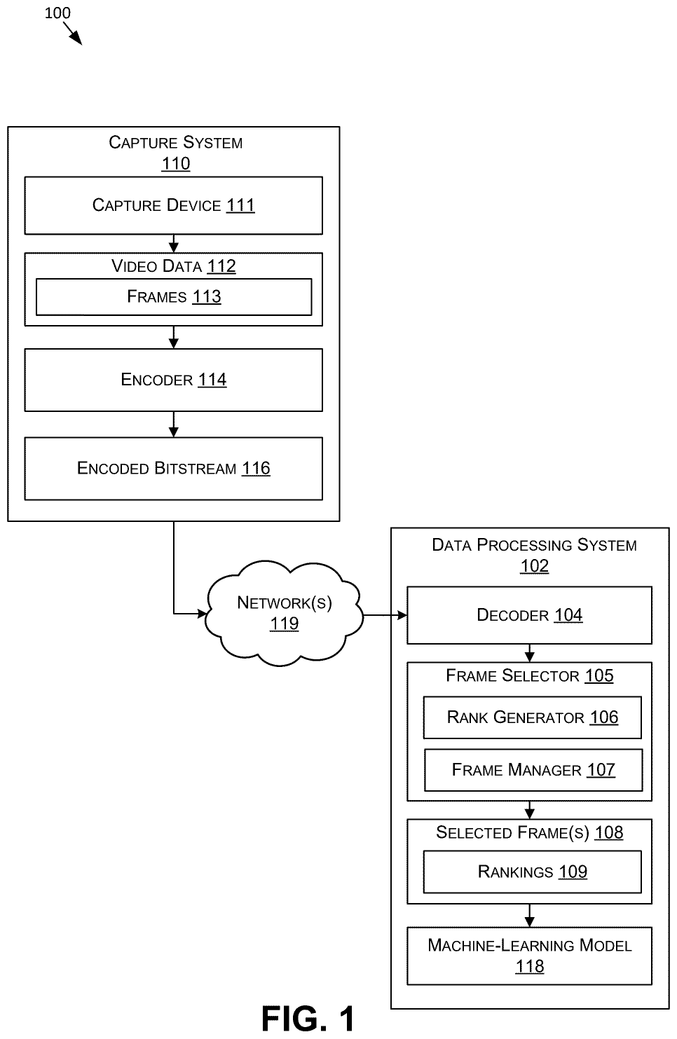

Referring now to FIG. 1, a block diagram of an example system 100 for implementing video stream generation for generative artificial intelligence systems, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory.

The system 100 can be utilized to generate rankings (e.g., ranking(s) 109) for frames 113 of video data 112 that can be used to determine subsets of frames to provide for processing by a machine-learning model 118. The system 100 is shown as including a capture system 110, a data processing system 102, and one or more networks 119. The capture system 110 is shown as including a capture device 111 that can generate video data 112 and can implement an encoder process 114 (sometimes referred to herein as an “encoder 114”) that generates an encoded bitstream 116 from the video data 112. The data processing system 102 is shown as implementing a decoder process 104 (sometimes referred to herein as a “decoder 104”), a frame selector process 105 (sometimes referred to herein as a “frame selector 105”) that identifies selected frame(s) 108 to provide as input to a machine-learning model 118. The frame selector process 106 can be used to rank frames and determine a subset of frames to be processed using machine-learning model(s) described herein, such as machine-learning model 118.

The capture system 110 can include any type of computing device that includes or is in communication with a capture device 111 that can capture video data 112. The capture system 110 can include, but is not limited to, a smartphone device, a tablet device, a laptop, a personal computer, a server, a distributed computing environment, a network-enabled camera device, or a surveillance camera device, among others. The capture system 110 is shown as being in communication with the network 119, and can transmit data (e.g., the encoded bitstream 116) to the data processing system 102 or one or more external systems for processing and/or storage.

The capture system 110 is shown as including one or more capture devices 111. A capture device 111 can include, but is not limited to, a digital video camera, a webcam, a smartphone camera, a surveillance camera, a vehicle-mounted camera, or another type of device that is capable of capturing sequences of images and/or video frames. The capture device 111 can be implemented using hardware or a combination of software and hardware. The capture device 111 can capture any type of video data 112, including color (e.g., red-green blue (RGB) video data), grayscale, or infrared video data.

The capture system 110 can capture video data 112 in response to input from an operator of the capture system 110 or in response to a signal received via the network 119. In some implementations, the video data 112 can be provided as part of a live video stream. In some implementations, the capture system 110 can capture and store recorded video data 112 that is subsequently transmitted to the data processing system 102 or an external system for storage and/or process. The video data 112 can include standard definition video, high-definition video, 4K video, or other types of video content. The video data 112 can include a predetermined or dynamic frame rate. For example, the video data 112 captured by the capture device 111 can have a frame rate of 24 frames-per-second, 30 frames-per-second, or 60 frames-per-second. The video data 112 can include color video data, grayscale video data, or other types of video data such as thermal imaging video, or three-dimensional video (e.g., RGB-D video data).

In some implementations, the video data 112 can be generated by one or more applications executed by the capture system. For example, the video data 112 can be generated from frames 113 produced by a video game application. The video data 112 can also be generated by other types of applications, such as remote desktop or remote access applications executing on the capture system 110. In such implementations, the frames 113 can be generated by one or more rendering processes executed by the capture system 110, which render frames 113 that depict, for example, three-dimensional environments, application interfaces, or other graphical information that can be generated by an application executing on the capture system 110.

Video data 112 captured or generated by the capture system 110 can be processed by the encoder 114 to generate an encoded bitstream 116. The encoder 114 of the capture system 110 can encode the video data 112 into a suitable format for transmission by generating an encoded bitstream 116 according to one or more codec standards. Encoding the video data 112 reduces the overall amount of information that is to be transmitted to the data processing system 102 or other external system for subsequent processing and/or storage. The encoder 114 can utilize any combination of hardware or software to encode the video data 112. Encoding the video data 112 can include converting the video data 112 to conform to any suitable video codec standard, including but not limited to an AVC (or h.264), HEVC (or h.265), VVC (or h.266), VP8, VP9, or AV1, or any other video codec standard. Similar codec standards can be utilized to encode audio data.

The encoder 114 can generate the encoded bitstream 116 continuously, for example, as frames are captured by the capture device 111 or generated from an application or source of the video data 112. The encoder 114 can generate the encoded bitstream to include a chronological sequence of encoded video frames. In some implementations, the encoder 114 can generate the encoded bitstream 116 subsequent to capturing and storing the video data 112 in memory of the capture system 110. In some implementations, the encoder 114 can generate the encoded bitstream 116 as a video file that is stored in memory of the capture system 110. The video file can be transmitted via the network 119 to one or more external systems (e.g., the data processing system 102) for subsequent processing and/or storage.

In some implementations, the encoder 114 can generate the encoded bitstream 116 to be transmitted as part of a video stream, for example, using a streaming protocol such as the real-time transport protocol (RTP). When transmitting streaming video via a streaming protocol, individual video frames can be transmitted via the network 119 in sequences of one or more network packets, with each packet including one or more regions (e.g., slices, tiles, contiguous sequence(s) of macroblocks, any other logical sub-unit of a video frame 113 that can be encoded as a distinct part of the encoded bitstream 116) of the video frame 113. In such implementations, the encoded bitstream 116 can be provided as part of a video streaming application, including but not limited to a recorded live stream, a game stream, or a remote desktop session, among others.

The optical flow system(s) of the capture system 110 can process frame(s) 113 of the video data 112 as they are captured by the capture device 111 or generated by an application executing on the capture system 110, in some implementations. The optical flow systems can implement different processes for generating motion vectors that correspond to features, objects, pixels, or regions of frames 113 of the video data. In some implementations, the optical flow system(s) can generate a motion vector or motion vector field for a frame 113 that indicates motion relative to one or more previous frame(s) 113. The motion vectors can be generated by the optical flow system(s) using any suitable technique, including but not limited to gradient-based methods (e.g., Horn-Schunck-based motion functions), feature-based methods (e.g., Lucas-Kanade-based motion functions), energy-based methods, or other types of motion estimation functions (e.g., phase correlation, template matching, etc.).

The capture system 110 can transmit the generated encoded bitstream 116 (e.g., including metadata of the frames) to the data processing system 102 via the network 119. The network 119 can include computer networks such as the Internet, local, wide, metro, or other area networks, intranets, satellite networks, other computer networks such as voice or data mobile phone communication networks, and combinations thereof. The network 119 can be any form of computer network that can relay information between the capture system 110, the data processing system 102, and one or more external systems, amongst others. In some implementations, the network 119 can include the Internet and/or other types of data networks, such as a local area network (LAN), a wide area network (WAN), a cellular network, a satellite network, or other types of data networks. The network 119 can also include any number of computing devices (e.g., computers, servers, routers, network switches, etc.) that are configured to receive and/or transmit data within the network 119. The network 119 can further include any number of hardwired and/or wireless connections. Any or all of the computing devices described herein can communicate wirelessly (e.g., via WiFi, cellular, radio, etc.) with a transceiver that is hardwired (e.g., via a fiber optic cable, a CAT6 cable, etc.) with other computing devices in the network 119. Any or all of the computing devices described herein can also communicate wirelessly with the computing devices of the network 119 via a proxy device (e.g., a router, network switch, or gateway).

The capture system 110 can transmit the encoded bitstream 116, including metadata, in one or more network packets to the data processing system 102. In some implementations, the capture system 110 can transmit the encoded bitstream 116 to a storage system separate from and accessible by the data processing system 102. The encoded bitstream 116 can be transmitted in real-time or near real-time, for example, as the encoded bitstream 116 are generated. In some implementations, the encoded bitstream 116 can be transmitted or otherwise provided via the network 119 subsequent to capturing and encoding the video data 112. For example, the encoded bitstream 116 and can be transmitted via the network 119 in response to operator input at the capture system 110, in some implementations.

The system 100 is shown as including a data processing system 102. The data processing system 102 can include one or more processors, circuits, memory, and/or computing devices/systems that can perform the various techniques described herein. The data processing system 102 can be implemented, for example, in a cloud computing environment, which can maintain, update, and/or execute one or more machine-learning models 118. The data processing system 102 can implement the various techniques described herein to selectively provide decoded frames (e.g., the selected frame(s) 108) as input to the machine-learning model 118, which can include a video language model.

As shown, the data processing system 102 can maintain, execute, and train/update one or more machine-learning models 118. In some implementations, the machine-learning model(s) 118 can include any type of multimodal machine-learning model capable of processing video data. For example, the machine-learning model(s) 118 can be trained/updated to process natural language text input, audio input, video input, or image input, among other media modalities. The machine-learning model(s) 118 can be or include a transformer-based model (e.g., a generative pre-trained transformer (GPT) model). The machine-learning model(s) 118 can be or include a VLM, in some implementations. In some implementations, the machine-learning model(s) 118 can include one or more tokenizer models, which are capable of converting media data into an encoded format (e.g., one or more tokens, or a “tokenized” format) that is compatible with the layers of the machine-learning model(s) 118.

The data processing system 102 can execute the machine-learning model 118 to generate output. The data processing system 102 can receive data to provide as input to the machine-learning model(s) 118, which can include text data, audio data, video data, image data, or combinations thereof. To efficiently transmit video information, the data processing system 102 can receive encoded video information (e.g., the encoded bitstream 116) to provide as input to the machine-learning model 118. In some implementations, the data processing system 102 can receive an identifier of encoded video data, which can indicate a network storage location for a corresponding encoded bitstream 116. The data processing system 102 can use the identifier to retrieve (e.g., from an external system) the encoded bitstream 116 for processing using the machine-learning model 118, as described herein.

In some implementations, the data processing system 102 can receive input data for the machine-learning model 118 from the capture system 110 via the network 119, which can include video data and/or text data. For example, an operator of the capture system 110 can provide input text data via one or more input devices (e.g., keyboard, touchscreen, etc.) of the capture system 110. The capture system 110 can capture and provide encoded bitstreams 116 that include video and frame metadata to the data processing system 102 for processing, as described herein. In some implementations, the encoded bitstream 116 can be provided with text data (e.g., a text input prompt) for the machine-learning model 118, among other types of multimedia data.

Upon receiving the input data for the machine-learning model 118, the data processing system 102 can convert the input data into a numerical format that is compatible with the input layers of the machine-learning model 118. To efficiently process the encoded bitstream 116, the data processing system 102 can execute a decoder 104. The decoder 104 can include software, hardware, or combinations of hardware and software that can decode encoded video information according to one or more codecs. Furthering the above example, the decoder 104 can decode the encoded bitstream 116 to reconstruct the frames 113 making up the raw video data 112. To do so, the decoder 104 can parse the encoded bitstream to extract any associated video metadata and/or frame metadata, including the codec or encoding algorithm used to generate the encoded bitstream 116. For example, the video metadata can include data such as the type of video content (e.g., sports, news, entertainment), resolution, and encoding parameters. In another example, individual frame metadata can include information such as timestamp, frame type (e.g., I-frame, P-frame, B-frame), motion vector data, and scene change indicators. The decoder 104 can execute a corresponding decoding algorithm that implements the inverse of the encoding processes used to generate the encoded bitstream 116.

The data processing system 102 can execute a frame selector process 106 (sometimes referred to herein as the “frame selector 105”). The frame selector 105 can include hardware, software, or combinations of hardware and software to perform the various functionalities described herein. The frame selector 105 can access the metadata generated or otherwise extracted by the decoder 104 to generate rankings 109 and determine a subset of frames (e.g., selected frames 108) to provide as input to the machine-learning model 118.

The frame selector process 105 (or “frame sampling process 105”) can include or can be in communication with a ranking process 106 (sometimes referred to as the “rank generator 106”) of the data processing system 102. Although the rank generator 106 is shown as a part of the frame selector 105, it should be understood that, in some implementations, the rank generator 106 can be separate from the frame selector 105. The rank generator 106 can include hardware, software, or combinations of hardware and software that access frames 113 (e.g., reconstructed by decoder 104) of the video data 112 to rank frames 113 to determine a subset of frames to store (e.g., by the frame manager 107) and be provided as input to the machine-learning model 118. The rank generator 106 can process the frame(s) 113 of the video data 112 continuously, for example, as the frames 113 are decoded by the decoder 104 or generated from an application or source of the video data 112 (e.g., executing on the data processing system 102 or from another external system in communication with the capture system via the network 119). The rank generator 106 can generate rankings 109 to be included or stored in association with the frames 113 used in modeling by the machine-learning model 118. As described in further detail herein, the rankings 109 can be used to indicate which frames are to be provided (e.g., based on individual rankings) as input to the machine-learning model 118 (or are to be subject to other processing operations, in some implementations).

Rankings 109 can be generated by the rank generator 106 for frames 113. In some implementations, each frame 113 (e.g., frame 0 to frame N+1) can be given a rank by the rank generator 106. In some implementations, some of frames 113 can be given a rank by the rank generator 106. For example, every two frames or predetermined number of frames can be given a rank. In this example, the number of frames being ranked can be dependent on the processing capacity and/or specific requirements of the machine-learning model. The rankings 109 generated by the rank generator 106 can be included as part of a corresponding frame 113. In some implementations, a ranking 109 can be a single bit, byte, or data structure assigned to a corresponding decoded frame. In some implementations, the rankings 109 can be provided as part of Supplemental Enhancement Information (SEI).

In some implementations, a ranking 109 can be generated for a frame 113 upon the rank generator 106 performing or implementing a ranking model. That is, the frame selector 105 can execute one or more machine-learning models (referred to herein as a “ranking model”) to generate a ranking 106 for a frame of video data. The machine-learning models can be stored in memory of the data processing system 102 and can include models trained and/or updated to rank frames based on specific video parameters, such as motion vectors, scene changes, bitrate variations, optical flow motion vectors, action recognition outcomes, activity detection outcomes, and/or object detection outcomes. The ranking models can be light-weight machine-learning models that can be executed in real-time or near real-time, as the encoded bitstream is decoded or otherwise provided by the data processing system 102. The ranking models of the frame selector 105 can include, but are not limited to, a convolutional neural network (CNN), a recurrent neural network (RNN), a long short-term memory (LSTM) network, or other types of machine-learning models.

The rank generator 106 can use the machine-learning models to generate a ranking 109 used to select or determine the subset of frames (e.g., selected frames 108). The ranking 109 can be generated based on a plurality of video parameters of the plurality of frames and the metadata of the video stream. For example, video parameters can include motion vectors, IDR frames, scene changes, bitrate variation, optical flow motion vectors, object detection results, activity recognition scores, feature detection results, or any other relevant video features. In some examples, the video metadata can include the event type (e.g., sporting event and/or the particular type of sporting event, event details, event duration, event intensity), video type (e.g., 4K, HD, SD, HDR), encoding parameters, compression level, or any other metadata associated with the video stream. The generation of rankings of frames 113 can use the machine-learning model(s) of the rank generator 106. To do so, the rank generator 106 can provide the frame 113 as input to the machine-learning model(s) and can execute the machine-learning model(s) to generate output including a rank (e.g., value between 0.00 and 2.00, specific score range, confidence intervals, thresholds for classification, weights for ranking criteria, or any other ranking metrics).

In some implementations, the machine-learning model(s) of the rank generator 106 can include one or more object detection (e.g., detection and/or tracker) models that are trained and/or updated to classify whether any predetermined objects, such as people, faces, or objects of interest are depicted in an input frame 113. For example, the object detection models can detect and/or track one or more objects within and/or across a plurality of frames. In some implementations, the machine-learning model(s) of the rank generator 106 can include one or more feature detection models that are trained and/or updated to classify whether any predetermined features are present in an input frame 113. Such features can include any attribute or aspect of the content depicted in the frame 113, including but not limited to indications that the frame 113 depicts a particular location, type of weather, or any other type of feature.

In some implementations, the machine-learning model(s) of the rank generator 106 can include one or more custom computer vision (CV) models that are trained and/or updated to assess whether the content within an input frame 113 is meaningful or relevant to the context of the video. For example, the custom CV models can analyze the overall composition of the frame, evaluating elements such as object prominence, scene complexity, and content relevance. In some implementations, the custom CV models can be trained and/or implemented to perform alongside object detection models or independently, providing additional insights into the importance of a frame based on specific visual characteristics. Such characteristics can include content-specific attributes or aspects of the frame 113, including but not limited to determining the presence of key activities, evaluating the focus of the frame, or identifying scenes of particular interest within the video.

In some implementations, the machine-learning model(s) of the rank generator 106 can include one or more event detection models that are trained and/or updated to classify the type of event present in an input frame 113. Such events can be classified from visual patterns in the frame 113 or from external data (e.g., newsfeeds, sensor data, user inputs, environmental data), including but not limited to real-time information feeds. In some implementations, the machine-learning model(s) of the rank generator 106 can include one or more action or movement recognition models that are trained and/or updated to identify movements or actions in an input frame 113. Such actions or movements can be classified from temporal sequences in the frame 113, including but not limited to gesture detection and/or movement tracking. For example, an action recognition model can differentiate between various types of human motion. In some implementations, the machine-learning model(s) of the rank generator 106 can include one or more activity detection models that are trained and/or updated to detect areas of activity in an input frame 113. For example, the activity detection models can detect one or more areas of the plurality of frames having activity (e.g., movement hotspots, crowd formation, object interaction zones). Such actions or movements can be classified from changes in pixel intensity in the frame 113, including but not limited to motion flow patterns.

Additional techniques can be implemented in addition to the use of machine-learning models to detect objects, features of interest, event types, actions or movements, and/or activity of interest. For example, the rank generator 106 can implement one or more image processing techniques prior to providing the frame(s) 113 as input to the machine-learning model(s). In one example, background subtraction can be applied to the frame(s) 113. In some implementations, denoising approaches can be used to remove noise from frames 113 prior to executing one or more machine-learning models. In another example, change detection functions can be executed to estimate the difference(s) between sequential frames, which can flag certain frames 113 to be provided as input to the machine-learning model(s) of the rank generator 106. Such change detection functions can include, but are not limited to image differencing, change vector analysis, or statistical hypothesis testing, among others.

Generally, the rank generator 106 can process each frame 113 through the ranking models (e.g., machine-learning models, such as convolutional neural networks (CNNs), recurrent neural networks (RNNs), long short-term memory (LSTM) networks, support vector machines (SVMs), or any heuristic trained and/or updated to rank frames based on specific video content attributes). One or more models can be applied to the input (e.g., video parameters and metadata contained within the frames 113) to generate a numerical ranking 109. The ranking 109 can quantify the relative importance of the frames 113 based on the specific attributes derived from the video data 112. For instance, the higher-ranked frame can be associated with significant motion or an event of interest, whereas a lower-ranked frame can be associated with static or less significant content. In some implementations, the rankings 109 can correspond to a summarization of the video stream. For instance, frames with higher rankings 109 can be selected to represent key moments or important segments of the video. In some instances, a sporting event video stream can prioritize frames where scoring events occur. That is, unlike current methods using fixed frame intervals to sample frames from the entire video, the rank generator 106 and frame manager 107 are implemented to dynamically select and retain frames based on their relevance and content significance rather than time intervals. Thus, the implementations described herein provide improvement to video content analysis and summarization processes by enhancing the selection and retention of frames that are most representative of the aspects of the content.

Additionally, the rankings 109 can be stored in association or otherwise linked with the corresponding frames 113, such that the frame manager 107 can use the rankings 109 for further processing. For instance, the rankings 109 can be stored as metadata within the frame data structure or in an associated database. In some implementations, the rankings 109 generated by the rank generator 106, based on the modeling of video parameters and metadata from the frames 113, can be used by the frame manager 107 to prioritize frames for input into the machine-learning model 118. The frame manager 107 can select frames 113 with the highest rankings 109 for further processing.

The ranking models used by the rank generator 106 can be trained and updated periodically to improve the accuracy in ranking frames based on video parameters and metadata of corresponding frames 113. Training can include feeding the models with labeled datasets that include frames annotated with the specific attributes (e.g., motion, scene changes, bitrate variations) that the models are intended to recognize and rank. During training, the models can learn to associate certain patterns in the video data 112 with higher or lower rankings 109 based on their relevance to the content. In some instances, a CNN can be trained to recognize spatial features that are indicative of important events in the video stream. In some instances, a RNN can be trained to detect temporal patterns that signify transitions or actions of interest. The training process can also include iterative updates to the model parameters, facilitating the refinement of the models to improve frame ranking accuracy based on the changing characteristics of the video data. In some implementations, the models can be retrained using new datasets that reflect changes in the types of video content being processed.

During training and implementation, the ranking models can apply weights to the different video parameters and metadata inputs to adjust their influence on the final ranking 109 assigned to each frame 113. Weighting can be used to prioritize certain features over others based on their relevance to the content being analyzed. For instance, in a news broadcast video stream, the model can assign higher weights to parameters, such as motion vectors and scene changes to emphasize dynamic content, while in a surveillance video stream, metadata related to detected objects or unusual activity might be given higher weighting. These weights can be fine-tuned during the training process to optimize the performance of the model. Additionally, during implementation, the models can dynamically adjust weights based on real-time analysis of the video stream, allowing the ranking to reflect the important aspects of the content at any given moment. In some implementations, the weighting of parameters can also be influenced by predefined criteria or user input.

In some implementations, the machine-learning models of the rank generator 106 can be executed to generate one or more rankings 109 of frames 113 based on specific criteria. Motion vectors generated by the encoder 114 when encoding the video data 112 can be decoded from the bitstream (e.g., by the decoder 104) and provided to the rank generator 106. The rank generator 106 can input the motion vectors generated by the encoder 114 to the ranking model to rank the corresponding frame 113. In some implementations, the ranking model can be trained and/or updated on motion threshold(s) and corresponding magnitudes of one or more motion vectors to generate rankings 109 for corresponding frames 113 in which the motion is depicted. For example, the motion threshold can be a video parameter and the ranking model can generate rankings based in part on detected motion intensity.

Instantaneous decoder refresh (IDR) frames (e.g., including I-slices (intra-coded picture) or SI-slices, corresponding to scene changes) generated by the encoder 114 when encoding the video data 112 can be decoded from the bitstream (e.g., by the decoder 104) and provided to the rank generator 106. The rank generator 106 can input the IDR frames (or scene changes) generated by the encoder 114 to the ranking model as a video parameter to be used in determining the rank of the frame based in part on scene changes. That is, while IDR frames can often be used by the frame selector 105 to mark frames currently stored in the buffer as unused for reference (e.g., no frames prior (to the IDR frame) is to be referenced) in some implementations, the rank generator 106 can use the IDR frames as a video parameter to model and rank frames. For example, the IDR frame can be inputted (e.g., with one or more frames 113 and other video parameters) into the ranking model to assess the importance of the frame within the video stream. In some implementations, the ranking model can be trained and/or updated on IDR frames and/or scene changes to generate rankings 109 for corresponding frames 113 (e.g., transitions, scene cut points, content shifts). For example, the IDR frames can be a video parameter and the ranking model can use them to enhance the accuracy of frame ranking.

The machine-learning models of the rank generator 106 can be executed to generate one or more rankings of frames based in part on bitrate variations. In some implementations, the rankings can be influenced by the changes in bitrate, which can correlate with changes in the complexity or importance of the video content. Bitrate variations occur as a result of the encoding process performed by the encoder 114, which adjusts the bitrate dynamically based on the complexity of the video data 112. These bitrate variations can be decoded from the bitstream (e.g., by the decoder 104) and provided to the rank generator 106. The rank generator 106 can input the decoded bitrate variation data to the ranking model to rank the corresponding frame 113. In some implementations, the ranking model can be trained and/or updated on thresholds associated with bitrate levels to generate rankings 109 for corresponding frames 113 where significant variations are observed. For example, the bitrate threshold can be a video parameter, and the ranking model can generate rankings based on the magnitude and frequency of bitrate changes.

Bitrate variations resulting from the encoding process by the encoder 114, and decoded from the bitstream by the decoder 104, can be provided to the rank generator 106. The rank generator 106 can input the bitrate variation data to the ranking model as a video parameter to be used in modeling the importance of the frame based on its associated bitrate. That is, the rank generator 106 can use the variations as a video parameter to model and rank frames. For example, the bitrate variation data can be inputted (e.g., with one or more frames 113 and other video parameters) into the ranking model to assess the relative complexity or importance of a frame within the overall video stream. In some implementations, the ranking model can be trained and/or updated on bitrate variations to generate rankings 109 for corresponding frames 113 (e.g., scenes with high detail, areas of significant motion, complex visual sequences). For example, the bitrate variations can be a video parameter, and the ranking model can use them to refine the selection process based on content complexity.

The machine-learning models of the rank generator 106 can be executed to generate one or more rankings of frames based in part on optical flow motion vectors. In some implementations, the rankings can be influenced by the magnitude and directionality of motion detected within the frames. Optical flow motion vectors can be generated by one or more optical flow processes executing on the data processing system 102. These optical flow processes can include hardware, software, or combinations of hardware and software that automatically generate motion data from frames captured using the capture device 111 of the data processing system 102. The optical flow motion vectors generated by these processes can be accessed via one or more application programming interfaces (APIs) of the data processing system 102 or one or more operating system(s) executing thereon. The rank generator 106 can retrieve the optical flow motion vectors via these APIs and input them to the ranking model to rank the corresponding frame 113. In some implementations, the ranking model can be trained and/or updated on motion vector thresholds and corresponding magnitudes of one or more optical flow motion vectors to generate rankings 109 for corresponding frames 113 in which the motion is depicted. For example, the motion vector threshold can be a video parameter, and the ranking model can generate rankings based on the intensity and pattern of motion as captured by the optical flow vectors.

Optical flow motion vectors generated by the optical flow processes can be retrieved by the rank generator 106 via the APIs provided by the data processing system 102. The rank generator 106 can input these optical flow motion vectors to the ranking model as a video parameter to be used in determining the significance of motion within the frame. That is, while optical flow vectors can often be used by the frame selector 105 to analyze movement patterns in the video, in some implementations, the rank generator 106 can use these vectors as a video parameter to model and rank frames. For example, the optical flow vectors can be inputted (e.g., with one or more frames 113 and other video parameters) into the ranking model to assess the relevance of the frame in capturing dynamic content. In some implementations, the ranking model can be trained and/or updated on optical flow motion vectors to generate rankings 109 for corresponding frames 113 (e.g., movement transitions, directional shifts, velocity changes). For example, the optical flow motion vectors can be a video parameter, and the ranking model can utilize the optical flow motion vectors to generate rankings based on detected motion characteristics.

The machine-learning models of the rank generator 106 can be executed to generate one or more rankings of frames based in part on metadata included in the SEI. In some implementations, the rankings can be influenced by metadata extracted from the SEI, such as scene descriptions, event type, video type, frame types, or object identification tags. The metadata can be encoded as part of the SEI within the encoded bitstream 116. The SEI data can include various metadata elements that are assigned to corresponding encoded frames in the encoded bitstream 116. The rank generator 106 can retrieve this SEI metadata as the bitstream is decoded by the decoder 104 and input it to the ranking model to rank the corresponding frame 113. In some implementations, the ranking model can be trained and/or updated based on attributes found in the SEI to generate rankings 109 for frames 113. For example, metadata attributes can complement or be used in combination with the video parameters, and the ranking model can adjust rankings based on the presence and significance of these metadata attributes found in the SEI.

Metadata included in SEI within the encoded bitstream 116 can be decoded by the decoder 104 and provided to the rank generator 106. The rank generator 106 can input this SEI metadata to the ranking model to be used in determining the relevance of the frame based on the associated SEI metadata. In some implementations, the rank generator 106 can use this metadata to model contextual and structural characteristics of the video content to rank corresponding frames 113. For example, the SEI metadata can be inputted (e.g., with one or more frames 113, other metadata, and video parameters) into the ranking model to model the importance of the frame within the overall video stream based on the metadata provided by the SEI. In some implementations, the ranking model can be trained and/or updated on specific types of SEI metadata to generate rankings 109 for corresponding frames 113 (e.g., frames containing scene change indicators, frames with object identification tags, frames marked with specific event information). For example, the ranking model can generate ranks based on the additional context provided by the SEI.

The rank generator 106 can receive frames 113 from the decoder 104, each frame containing associated video parameters and metadata. The video parameters derived from the frames 113 can include motion vectors, scene changes, bitrate variations, and optical flow motion vectors. The metadata can include information from the SEI, such as scene descriptions, event types, video types, and object identification tags. The rank generator 106 can input each frame 113, along with its corresponding video parameters and metadata, into one or more ranking models to generate rankings 109.

The frame selector process 105 (or “frame sampling process 105”) can include or can be in communication with a frame management process 107 (sometimes referred to as the “frame manager 107”) of the data processing system 102. Although the frame manager 107 is shown as a part of the frame selector 105, it should be understood that, in some implementations, the frame manager 107 can be separate from the frame selector 105. The frame manager 107 can include hardware, software, or combinations of hardware and software that access frames 113 (e.g., reconstructed by decoder 104 and ranked by the ranking generator 106) of the video data 112 to manage storage of a subset of frames (e.g., the selected frames 108) to be provided as input to the machine-learning model 118. The frame manager 107 can process the ranked frame(s) 113 of the video data 112 continuously, for example, as the frames 113 are ranked by the ranking generator 206. The frame manager 107 can select a subset of frames to be stored in a buffer to be used in modeling by the machine-learning model 118.

The frame manager 107 can receive the ranked frames 113 from the rank generator 206. The frame manager 107 can process the ranked frames 113 upon receipt, determining which frames are to be stored in the frame cache. The frame manager 107 can retain the N highest-ranked frames in the frame cache, where N is determined based on the specific requirements of the data processing system 102 or the machine-learning model 118. For instance, a subset of the frames in a video stream can be provided to a buffer (e.g., for retention) based on rankings 109. In some instances, the selected frames 108 (e.g., subset) can be provided continuously such that the buffer is updated in real-time as new frames are ranked. In some instances, the subset can be provided in batches such that only the highest-ranked frames in each batch are retained. In some implementations, once the buffer is full or at capacity, the frame manager 107 can replace the lowest-ranked frames with newly ranked higher-ranked frames. For instance, the buffer can employ a first-in, first-out (FIFO) approach to manage frame replacement when the buffer reaches capacity.

In some implementations, the buffer can be a circular buffer that can be configured to retain the highest-ranked frames by overwriting the lowest-ranked frames when new, higher-ranked frames are received. In some implementations, the buffer can be a priority buffer that can be configured to store only the highest-ranked frames within a predefined storage capacity, removing lower-ranked frames as necessary to accommodate new, higher-ranked frames. In some implementations, during a long video stream (e.g., over 10 minutes, over 1 hour), the frame manager 107 can allocate or otherwise store ranked frames in multiple buffers. That is, chunking can be used to divide the video stream into segments, with each buffer retaining the highest-ranked frames for its respective segment. For instance, each buffer can correspond to a time period of the video stream. In some instances, a first buffer can store the highest-ranked frames from the first segment of the stream and a second buffer can store the highest-ranked frames from the subsequent segment. Additionally, the frame manager 107 can overlap the time periods (e.g., an overlapping window) such that the time periods of consecutive buffers overlap, allowing frames to be stored in both buffers. For instance, the frame manager 107 can overlap the time periods (e.g., an overlapping window) such that the last two minutes of frames in one segment overlap with the first two minutes of frames in the next segment, allowing high-ranked frames to be stored in both buffers. For instance, frames that rank highly at the end of one segment and the beginning of the next segment can be retained in both buffers. In some implementations, a first priority buffer can be used to store frames with the highest rankings from the initial segment of the video stream, and a second priority buffer can be used to store frames with the highest rankings from a subsequent segment of the video stream. Additionally, in some implementations, a first priority buffer can store the first N highest-ranked frames, while the second priority buffer can store the next N highest-ranked frames (e.g., from the video stream and/or video segment).

In some implementations, the frame manager 107 can continuously manage the frame cache, ensuring that only the N highest-ranked frames are retained. The determination of how many frames to store in the cache can vary depending on a combination of factors or variables such as, but not limited to, available memory resources, processing power of the machine-learning model 118, desired output quality, real-time processing constraints, video content characteristics frame resolution, bitrate, or any other operational parameters. For instance, a high-motion video stream can require more frames to be retained to capture the dynamic content. In some implementations, as new ranked frames 113 are received, the frame manager 107 can compare the new frames with the existing frames in the cache. For instance, if a newly received frame has a higher rank than one of the currently stored frames, the frame manager 107 can replace the lower-ranked frame with the newly received higher-ranked frame.

In some implementations, the frame manager 107 can selectively provide ranked frames 113 based on various predefined parameters such that some but not all of the highest-ranked frames are selected for retention. For instance, when multiple frames in a row or consecutive frames contain a high ranking, the frame manager 107 can retain a subset of those frames based on predefined criteria to reduce redundancy while maintaining a representative selection of the video content. That is, a minimum distance metric can be employed to verify selected frames are sufficiently distinct from one another (e.g., in time). In some instances, the frame manager 107 can also remove older ranked frames when new frames with higher or similar rankings are received. As shown, the selected frames 108 can be a summarization and/or representation of the video stream such that key or important moments, actions, or content are retained.

Additionally, the frame manager 107 can be employed to populate the frame cache with the highest-ranked frames by executing a replacement process in real-time. That is, replacing can include replacing frames with lower rankings as higher-ranked frames become available. For instance, the frame manager 107 can continuously monitor the ranking of incoming frames and update the cache accordingly. In some implementations, the frame manager 107 can provide the selected frames from the cache as input to the machine-learning model 118. Frames 113 identified as the selected frames 108 (e.g., according to individual rankings) can be stored (e.g., in buffer memory, used as cache) in one or more data structures for further processing by the data processing system 102.

In some implementations, the frames that are unselected (e.g., based on rankings 109) can be discarded. In some implementations, the frames that are unselected (e.g., based on rankings 109) can be temporarily stored (e.g., in buffer memory) for potential future use. In some implementations, rather than being discarded, the frames 113 generated by the decoder 104 can be used in other processing operations implemented by the data processing system 102 or computing systems in communication with the data processing system 102. In some implementations, data of the selected frames 108 can be stored in chronological order, such that selected frames 108 that are provided as input to the machine-learning model are in the order they appear in the video data 112. In some implementations, data of the selected frames 108 can be stored according to rank, such that selected frames 108 are provided as input to the machine-learning model 118 in the order they are ranked, such that the machine-learning model 118 can prioritize the analysis of the most relevant frames.

The data processing system 102 can execute the machine-learning model 118 using the selected frame(s) 108 as input to generate corresponding output. In some implementations, and as described herein, the machine-learning model 118 can include a VLM, which can receive both text data input and video data input to generate output. It should be understood that, although the following examples are described with reference to a VLM, that any type of machine-learning model that processes video data can be utilized in connection with the techniques described herein.

The data processing system 102 can use one or more tokenizer models and/or embeddings models to convert the input data (e.g., the selected frames 108, any input text data or other media data, etc.) into a numerical representation that is compatible with the input layers of the machine-learning model 118. Various techniques can be used to convert the selected frames 108 into video information, including but not limited to an embeddings model and/or embeddings layers of the machine-learning model 118, or embeddings models that convert both the selected frame(s) 108 and additional text and/or multimedia data into the same embeddings space. Different embeddings spaces can be implemented for different media modalities of the input data, in some implementations. The resulting embeddings, once generated, can be provided as input to the machine-learning model 118 for processing to generate corresponding output data.

The data processing system 102 can execute the machine-learning model 118 by autoregressively generating output tokens and/or embeddings, in some implementations. The data processing system 102 can perform the mathematical operations of each layer of the machine-learning model 118, propagating the results of each layer to the next layer for processing until output is generated at one or more output layers. In an example where text data is generated as output, the machine-learning model 118 can include one or more output layers that generate one or more output distributions of token probabilities (e.g., from an output softmax layer, etc.). The data processing system 102 can use one or more configuration settings to select one or more tokens from the output distribution(s) for inclusion in output response. The data processing system 102 can execute the machine-learning model 118 autoregressively, to model sequences of output tokens corresponding to one or more media modalities, including, video data, image data, audio data, and/or text data. For example, the data processing system 102 can execute the machine-learning model 118 to predict one or more next tokens in an output sequence, which can then be included in the input context for the next iteration, as described herein.

The data processing system 102 can execute the machine-learning model 118 iteratively, incorporating previously generated tokens/embeddings as context for generating subsequent output, until a termination condition has been satisfied. One type of termination condition can be a context length limit or a configurable limit on the number of tokens that can be generated and/or processed by the machine-learning model 118. In some implementations, the termination condition can be satisfied when the machine-learning model 118 generates an output that represents the end of a response. The machine-learning model 118 can be trained/updated to be a conversational agent, in some implementations. For example, the machine-learning model 118 can generate realistic natural language in response to natural language input with video data. In one non-limiting example, the machine-learning model 118 can include a VLM that generates natural language output that summarizes actions/activity that occurs in input video data.

Once the termination condition for executing the machine-learning model 118 has been detected, the data processing system 102 can convert any encoded output generated by the machine-learning model 118 into a decoded format for storage, transmission, or further processing. In some implementations, this can include performing an inverse operation from the embeddings generation/tokenization process used to convert the input data to a format compatible with the machine-learning model 118. Once the output has been converted into a suitable format, the data processing system 102 can perform further processing operations using the converted output. For example, the data processing system 102 can store the output in association with the input for the machine-learning model 118. In another example, the data processing system 102 can transmit the converted output to the capture system 110 as a response to a prompt (e.g., text data with an encoded bitstream 116) provided by the capture system 110.

In some implementations, the selected frames 108 can be used to update the machine-learning model 118. For example, a training and/or update dataset can be generated using the selected frames 108 generated from an encoded bitstream 116 according to the techniques described herein. For example, the selected frames 108 can be paired with corresponding input text prompt data and expected output data (e.g., ground truth data), which is subsequently used to implement a supervised learning approach to update the parameters of the machine-learning model 118, for example, in an implementation where the machine-learning model 118 is a VLM. Similar techniques can be used to update the parameters of different types of machine-learning models 118, where expected ground truth data is generated for/paired with input sets of selected frames 108 as training/update examples. Any suitable training/update approach can be used to update the parameters of the machine-learning model 118, including but not limited to supervised learning, unsupervised learning, semi-supervised learning, or self-supervised learning, among others. Parameters of the machine-learning model 118 can be updated using a suitable optimization algorithm (e.g., a gradient descent function, Adam optimizer, etc.).

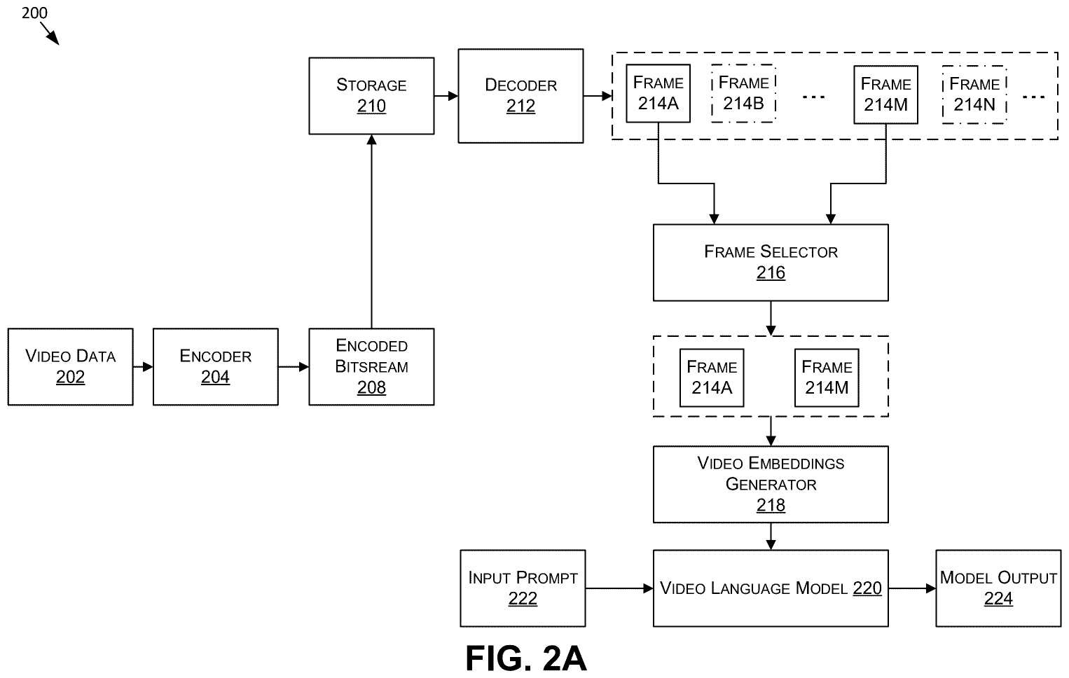

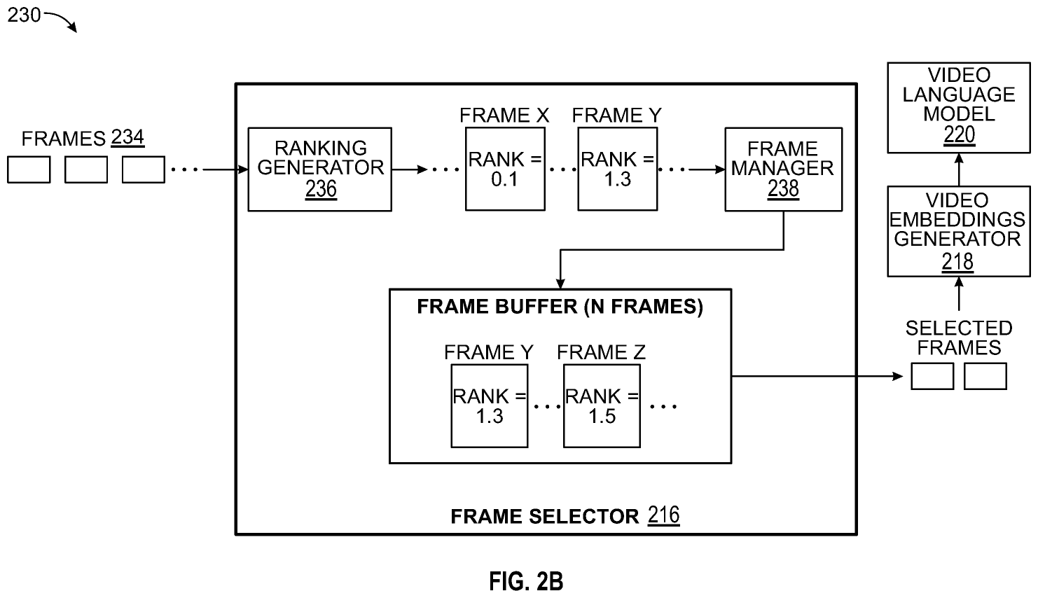

Referring to FIG. 2A in the context of the components described in connection with FIG. 1, illustrated is a dataflow diagram showing how frames are sampled for training and/or updating machine-learning models, in accordance with some implementations of the present disclosure. The process 200 shown in the dataflow diagram can be performed, for example, by the capture system 110 and the data processing system 102 of FIG. 1, as described herein. The process 200 provides an example overview of how video data 202 (e.g., the video data 112) can be captured and processed to rank frames for processing using a video language model 220 (e.g., the machine-learning model 118).

As shown, video data 202 can be processed into an encoded bitstream 208 (e.g., the encoded bitstream 208) using an encoder 204 (e.g., the encoder 114). The encoder 204 can process the video data 202 using a suitable encoding technique, for example, a video codec such as AVC (or h.264), HEVC (or h.265), VVC (or h.266), VP8, VP9, or AV1, or any other video codec standard. The encoder 204 can process frames of the video data 202 and can generate metadata for the frames to store as part of SEI in the frames. The metadata can include a bit, byte, data structure, or other SEI for the encoded bitstream 208.

Once generated, the encoded bitstream 208 can be provided to one or more storage systems 210 for subsequent processing. In some implementations, the encoded bitstream 208 can be generated as part of a live video stream and can be provided to a decoder process 212 (e.g., the decoder 104) rather than being provided to a storage system 210. The storage system 210 can be any type of system that can store encoded bitstreams 208 for subsequent processing by the video language model 220. Additionally, the storage system 210 can be or include the data processing system 102 of FIG. 1. In some implementations, the storage system 210 can be different from and accessible by any system (e.g., the data processing system 102) that executes the video language model 220.

The decoder 212 can generate frames 214A-214N (sometimes referred to as frames 214), which can be similar to or the same as frames 113 of the video data 112 of FIG. 1, from the encoded bitstream 208. In this example, frames 214A, 214B, 214M, and 214N, and so on can be provided for selection. The frame selector process 216 (similar to, e.g., the frame selector 106 of FIG. 1), can rank and retain the highest ranked frames (e.g., frames 214A and 214M) to provide as input to the video language model 220, as shown. In some implementations, the frame selector process 216 can include receiving a plurality of frames and metadata from a capture device capturing a video stream. For instance, the decoder can provide a decoded bitstream for modeling. In some implementations, the frame selector process 216 (e.g., rank generator 106 of FIG. 1) can use at least one ranking model to generate a plurality of rankings for the plurality of frames based on a plurality of video parameters of the plurality of frames and the metadata of the video stream. For instance, the ranking model can analyze motion vectors, scene changes, and object detection metadata to prioritize frames that contain activity of importance or transitions. In some implementations, the frame selector process 216 (e.g., frame manager 107 of FIG. 1) can determine at least one of the plurality of frames to provide to at least one first buffer based on the plurality of rankings. For instance, the frame manager 107 can select the top N ranked frames to store in the buffer for further processing by the video language model 220. Additional information regarding the selector process 216 is provided below with reference to FIG. 2B.

Any frames selected by the frame selector process 216 (in this example, the frames 214A and 214M) can be stored in a frame cache (e.g., buffer) and retained to be provided as input to a video embeddings generator process 218. The video embeddings generator process 218 can include one or more embeddings models that are trained/updated to convert input frame data into a numerical format that is compatible with the input layer(s) of the video language model 220. The video embeddings generator process 218 can generate embeddings for each frame individually or can generate a set of embeddings using a sequence of selected frames, in some implementations.

The output of the video embeddings generator process 218 is provided as input to the video language model 220. In this example, the video language model 220 can receive an input prompt 222 in addition to the frames selected by the frame selector process 216. The input prompt 222 can include any type of multimedia data, such as text data, image data, or audio data, among others. In some implementations, the input prompt 222 can be converted into a numerical format that is compatible with one or more input layers of the video language model 220 using a corresponding embeddings/tokenizer model, as described herein. In some implementations, the video language model 220 can receive a query (e.g., input prompt 222) regarding content of the video stream. For instance, the query can be a natural language question such as “What were the key moments in the last 10 minutes of the video?”. In response, the video language model 220 can generate an output (e.g., model output 224) based on the first subset of frames. That is, the output can include a response to the query extracting video content of the video stream. For example, the model output 224 can summarize the key events detected in the selected frames, providing a description of the video content relevant to the query.

The video language model 220 can be executed using the input prompt (which can be encoded/tokenized) and the output of the video embeddings generator process 218 to generate the model output 224. The video language model 220 can be trained/updated to generate any type of output, including text data, image data, video data, or audio data, among others. In one example, the video language model 220 can be trained/updated to generate output text data as the model output 224. Furthering this example, the input prompt 222 can include a natural language request to summarize any events that occur in the video data 202. The model output 224, when generated, can include natural language text that summarized any events that are depicted in the video data 202 to respond to the request. The video language model 220 can be implemented as part of a conversational agent, in some implementations.

Referring to FIG. 2B in the context of the components described in connection with FIG. 1, illustrated is another dataflow diagram showing how frames are sampled for training/updating machine-learning models, in accordance with some implementations of the present disclosure. FIG. 2B depicts a system 230 that includes a frame selector process 216 (e.g., the frame selector 106). Frames 234 (e.g., frames 113) from a video stream are input to the ranking generator 236 (e.g., rank generator 106). The ranking generator 236 can model and assign a rank to each frame based on video parameters and metadata associated with the frames. That is, a ranking model can be trained and implemented that can assign ranks based on activity in the frame derived from various video stream parameters and associated metadata.

In some implementations, the parameters can include motion vectors obtained from the decoder, IDR frames indicating scene changes, bitrate variations, and optical flow motion vectors, and the metadata can include information such as frame type, event type, or object identifiers. The ranking model can also integrate outputs from additional light-weight models that detect activity, such as action recognition models, custom computer vision models, object detection models coupled with object trackers, and activity detection focused on regions of interest (ROI). For instance, the ranking model can prioritize frames showing significant motion or scene changes, or those with specific metadata tags indicating key events. In another instance, frames that include detected objects or activities within a specific ROI can be assigned higher ranks. As shown, frame X can be assigned a rank of 0.1, and frame Y is assigned a rank of 1.3.

In some implementations, the ranked frames (e.g., frame X, frame Y) can be managed by the frame manager 238 (e.g., frame manager 107). The frame manager 238 can determine which frames are to be stored in a frame buffer, prioritizing the N highest-ranked frames. As shown, frames Y and Z are stored in the frame buffer with ranks of 1.3 and 1.5, respectively. The frame manager 238 can operate to maintain the highest-ranked frames within the buffer. In some implementations, the selected frames from the frame buffer can be passed to the video embeddings generator 218. The video embeddings generator 218 can convert the selected frames into embeddings compatible with the input layer of the video language model 220. The embeddings generated can then be used by the video language model 220 for further processing.

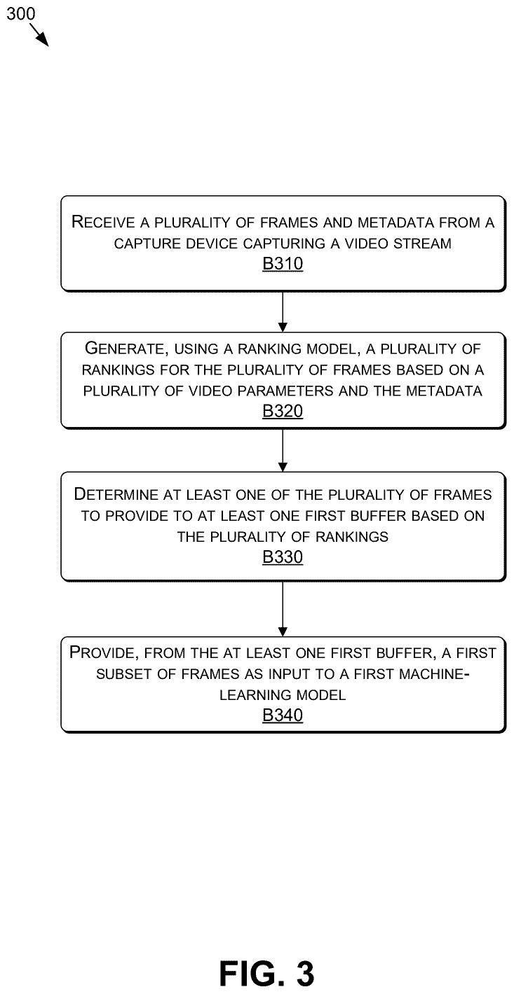

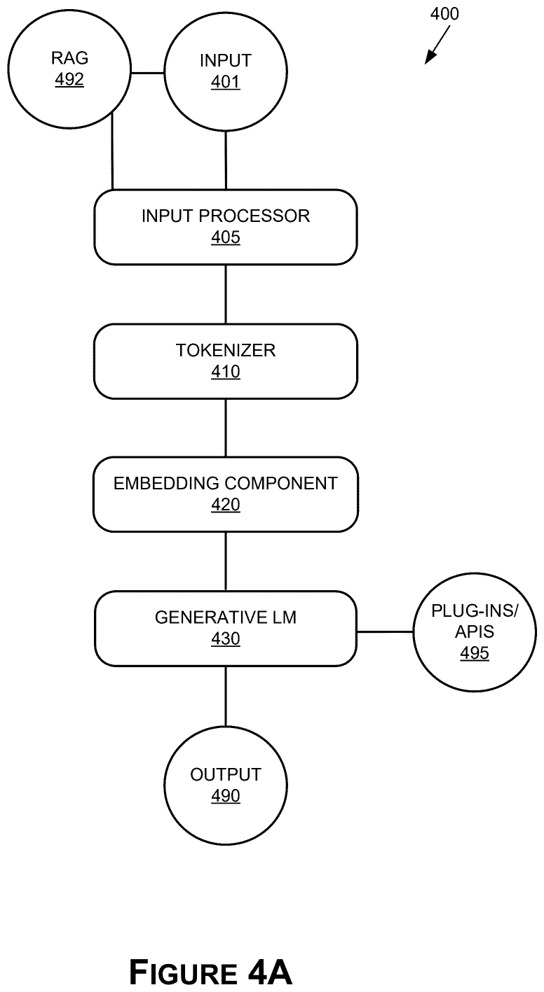

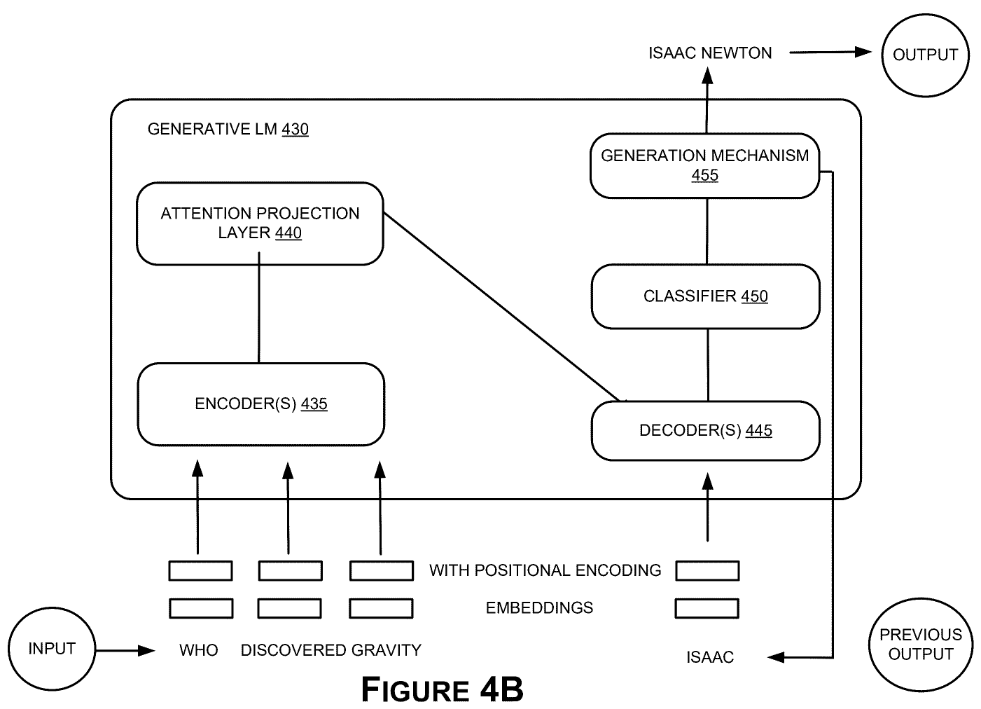

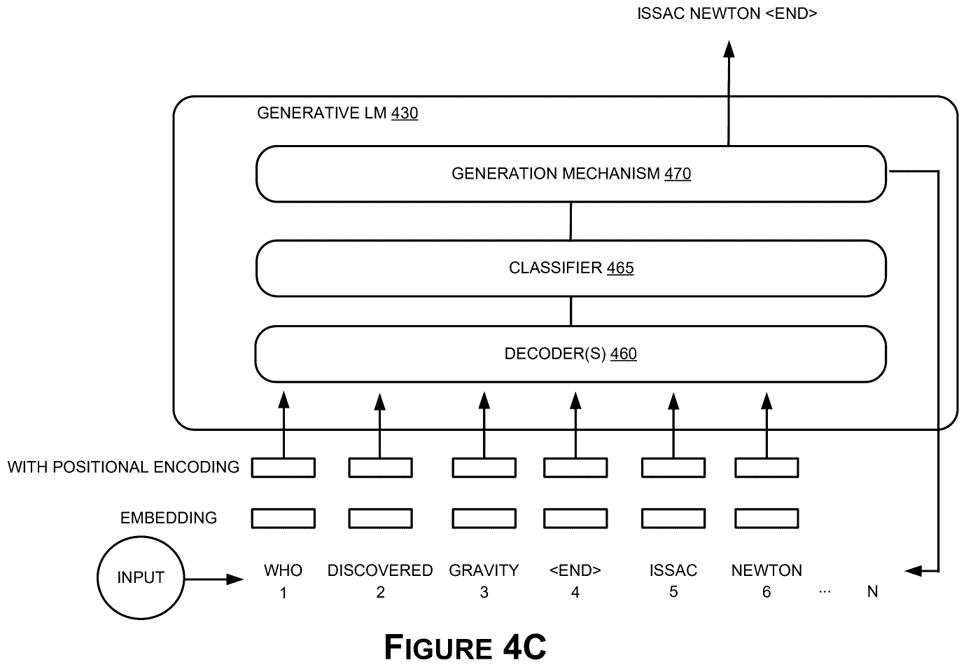

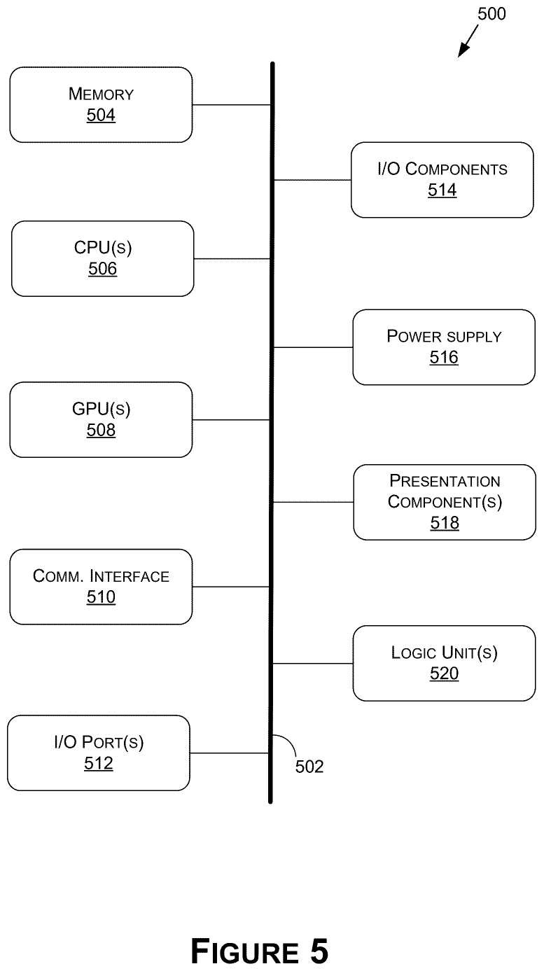

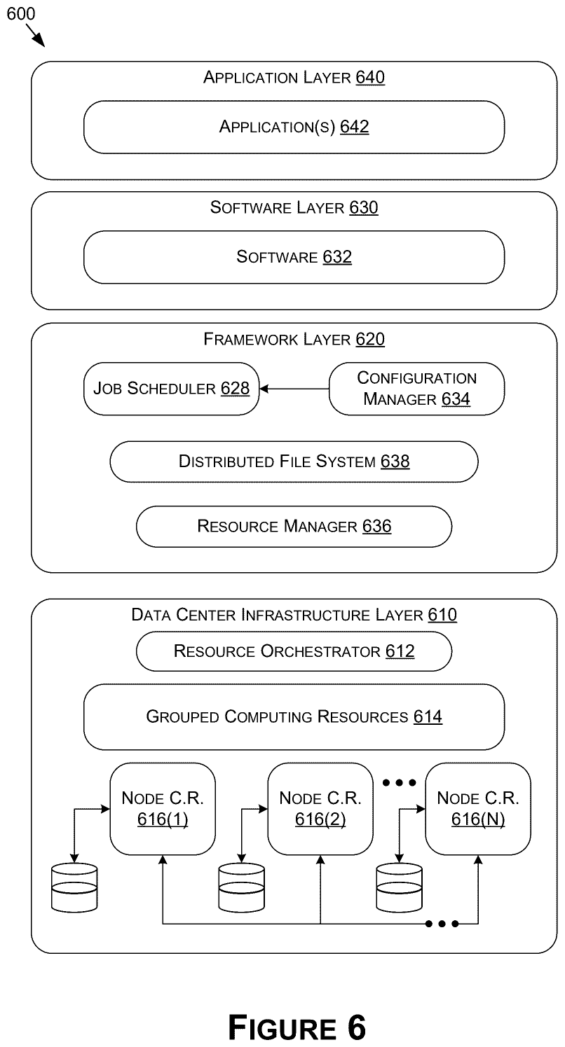

With reference to FIG. 3, FIG. 3 is an example flow diagram illustrating a method for ranking and selecting frames for video analysis, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out using one or more processor executing instructions stored in one or more memories. For example, in some implementations, the system and methods described herein can be implemented using one or more generative language models (e.g., as described in FIGS. 4A-4C), one or more computing devices or components thereof (e.g., as described in FIG. 5), and/or one or more data centers or components thereof (e.g., as described in FIG. 6).

Now referring to FIG. 3, each block of method 300, described herein, includes a computing process that can be performed using any combination of hardware, firmware, and/or software. For instance, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 300 is described, by way of example, with respect to the system of FIG. 1. However, this method can additionally or alternatively be executed by any one system, or any combination of systems, including, but not limited to, those described herein.

FIG. 3 is a flow diagram showing a method 300 for receiving, ranking, and selecting frames based on video parameters and metadata for further processing, in accordance with some implementations of the present disclosure. Various operations of method 300 can relate to improving the efficiency and accuracy of frame selection for machine-learning models, particularly in video analysis applications. Existing systems often rely on fixed frame sampling intervals, leading to redundant or missed important frames. The existing technological problems can arise when frames that capture key actions or events are not selected due to rigid sampling methods, resulting in inaccurate analysis or summaries. Method 300 and the systems of FIG. 1 and dataflow diagrams of FIGS. 2A-2B can solve these technological problems by implementing a dynamic ranking system that uses video parameters and metadata to prioritize and select relevant frames, thereby optimizing the frame selection process. This method enhances the overall effectiveness of machine-learning models in video processing by selecting pertinent frames for utilization, leading to better performance in tasks such as video summarization, object detection, custom computer vision model, and event recognition.

The method 300, at block 310, includes receiving a plurality of frames and metadata from a capture device capturing a video stream. The metadata can be part of the SEI of the decoded frame. For instance, the metadata can be capture information, subtitle information, video type information, event type, and/or video type. In some implementations, prior to receiving the frames, the one or more processors can receive an encoded bitstream of the video stream and decode the encoded bitstream to extract the plurality of frames. Additionally, the processors can extract (e.g., by decoding) a plurality of video parameters, and the metadata of the video stream from the encoded bitstream. In some implementations, the metadata of video stream can include text data of the video stream and of text data of content within the plurality of frames. For instance, the text data of the video stream and of the content can include at least a type of video (e.g., sports, news) and an event type being videoed (e.g., goal scored, interview).

The method 300, at block 320, includes generating, using a ranking model (e.g., machine-learning model, frame ranking heuristic or algorithm), a plurality of rankings for the plurality of frames based on a plurality of video parameters of the plurality of frames and the metadata of the video stream. For instance, the ranking model can prioritize frames with significant motion, scene changes, or specific metadata tags. That is, the plurality of rankings correspond to a summarization of the video stream. In some implementations, the video parameters can include motion vectors, IDR frames, scene changes, bitrate variation, optical flow motion vectors, or any relevant video feature detected during decoding. In some implementations, a rank can be generated for each frame received, from frame 0 to frame N+1. Additionally, the summarization can be represented in the plurality of rankings corresponding to the determination of the first subset of frames representing one or more temporal or spatial segments of the video stream. That is, the rankings can be a summarization of the video content identifying select frames from various parts of the video stream. For instance, the rankings can indicate key moments, such as goals or fast-paced actions, across the entire video.

In some implementations, generating, using the ranking model, the plurality of rankings can include applying differential weighting to the plurality of video parameters. For instance, motion vectors can be weighted more heavily than bitrate variations in sports footage to emphasize action. That is, at least one first video parameter (e.g., motion vectors) can be assigned a higher weight according to the ranking model than at least one second video parameter (e.g., bitrate variations) based on the metadata (e.g., event type, video type) of the plurality of frames. For instance, the weighting can be adjusted based on whether the video is classified as fast-paced (e.g., sports) or slow-paced (e.g., interviews).

In some implementations, the video parameters can include one or more motion vectors obtained from the encoded bitstream. That is, the one or more motion vectors can correspond to movement data of one or more objects in the plurality of frames. For instance, motion vectors could indicate rapid movement during a play in a sports video. In some implementations, the video parameters can include instantaneous decoder refresh (IDR) frames or scene change indicators obtained from the encoded bitstream. That is, the IDR frames or scene change indicators can correspond to content updates in the plurality of frames. For example, scene change indicators can signal a transition between two different shots during an event, such as a switch from a wide shot to a close-up. In some implementations, the video parameters can include one or more bitrate variations obtained from the encoded bitstream. That is, the one or more bitrate variations can correspond to data rate updates used to encode the video stream. For instance, bitrate variations can indicate changes in the complexity of the visual content, such as an increase in detail during a fast-moving scene. In some implementations, the video parameters can include one or more optical flow motion vectors obtained from the encoded bitstream. That is, the one or more optical flow motion vectors can correspond to movement data of one or more objects in consecutive frames of the plurality of frames. For example, optical flow motion vectors can indicate the direction and speed of movement within the scene, such as the trajectory of a ball during a game. The ranking model can use various video parameters with various weights to rank the frames. That is, the ranking model can be trained and/or implemented using the video parameters by applying different weights to each parameter based on the content type and metadata, enhancing the accuracy in ranking frames.

In some implementations, generating the plurality of rankings can include using a third machine-learning model (e.g., one or more custom computer vision (CV) models). That is, the third machine-learning model can perform or employ a lightweight model to detect activity (e.g., temporal activity) or implement custom computer vision (CV) algorithms to assess whether meaningful content is present in a video frame. For instance, the third machine-learning model can implement and/or update an action recognition model, an object detection model and/or object tracker model, or perform activity detection in ROI. Additionally, custom CV models can be used to analyze content quality and relevance within the frame. In some implementations, the third machine-learning model can be used to determine a rank in combination with the ranking model. For instance, the ranking output and frame outputted by the ranking model can be used as input to the third machine-learning model. In this instance, the third machine-learning model can output an adjusted ranking that reflects the detected activities, objects, or content significance in the frame. In some implementations, the third machine-learning model can be used in parallel with the ranking model to determine a rank. For instance, the third machine-learning model can operate simultaneously with the ranking model to analyze different aspects of the video stream, such as object presence, motion intensity, and content quality. In this instance, the third machine-learning model can output additional ranking data that can refine the overall ranking provided by the ranking model, enhancing the selection process by incorporating content relevance.

In some implementations, the third machine-learning model can be used to detect one or more actions or movements (e.g., a player kicking a ball, a car accelerating, a person waving) within the plurality of frames to increase an efficiency metric of the ranking model. That is, an efficiency metric can be processing speed, ranking accuracy, resource utilization, or any other relevant performance metric. An efficiency metric can be increased when the third machine-learning model effectively filters frames to reduce the number of non-informative frames processed. For instance, the detection of specific actions or the implementation of custom CV algorithms to verify content relevance can improve the ranking process by discarding frames that lack meaningful content. In some implementations, the third machine-learning model can be used to detect and/or track one or more objects within the plurality of frames to generate the plurality of rankings using the ranking model further based on prioritizing a first type of object of the one or more objects over a second type of object of the one or more objects. That is, the ranking model can assign higher importance to objects deemed more relevant to the video content, such as players in a sports game over spectators. For instance, the detection and prioritization of key objects, combined with content relevance checks, can improve the selection of frames that capture the important aspects of the video.

In some implementations, the third machine-learning model can be used to identify one or more areas of the plurality of frames to detect activity to generate the plurality of rankings using the ranking model further based on prioritizing a first area of the plurality of frames over a second area of the plurality of frames. Custom CV algorithms can also be applied to determine whether these areas contain meaningful content, such as faces, objects, or significant movements, before assigning a higher rank. That is, regions within the frame where significant activity or content occurs can be weighted more heavily in the ranking process. For instance, in a surveillance video, areas where movement or important objects are detected might be prioritized over static or less significant regions. The integration of content relevance checks ensures that the ranking process not only considers activity but also the quality and importance of the content within those activities.

The method 300, at block 330, includes determining at least one of the plurality of frames to provide to at least one first buffer (e.g., frame cache) based on the plurality of rankings, wherein the at least one first buffer stores a first subset of frames (e.g., retain N highest ranked frames) of the plurality of frames. That is, the one or more processors can maintain the at least one first buffer containing a predetermined maximum number of frames (e.g., N frames) based on the plurality of rankings. That is, the rankings can determine the maximum number of frames when the buffer reaches its predefined capacity. For instance, if the buffer can store up to 100 frames, and a new frame with a higher ranking is processed, the lowest-ranked frame can be discarded to accommodate the new one.

In some implementations, the first subset of frames can be further determined based on a plurality of similarity metrics (e.g., similarity between frames, such as visual similarity, temporal proximity) of the plurality of frames. That is, the plurality of similarity metrics can be determined using at least one of (i) a cosine distance, (ii) a Siamese network, (iii) a structural similarity, or (iv) background subtraction. For example, a cosine distance can be determined by calculating the angular difference between feature vectors of two frames. In this example, the similarity metric can be used to identify frames with closely related content, which can be redundant. In another example, a Siamese network can be determined by using a pair of neural networks to compare frames and output a similarity score. In this example, the similarity metric can be applied to filter out frames that are too similar to each other. In yet another example, a structural similarity can be determined by comparing pixel patterns and structures between two frames. In this example, the similarity metric can be used to assess visual content similarity. In yet another example, background subtraction can be determined by detecting differences between the foreground and background in consecutive frames. In this example, the similarity metric can be used to focus on changes in the scene that are relevant to the ranking process.

In some implementations, the first subset of frames can be further based on a minimum distance metric between the plurality of frames. That is, the one or more processors can perform a verification that the selected frames are sufficiently distinct from one another. For example, the minimum distance metric can include calculating the temporal or spatial separation between frames to ensure diversity in the selected frames. In this example, when multiple frames close in time are ranked high, some of the frames can be discarded because of the minimum distance metric. In this example, the minimum distance metric can be based on a predefined threshold, such as a minimum number of frames or time units, such that frames that are too similar or too close in time are not redundantly selected.

In some implementations, the one or more processors can store a plurality of non-selected frames from the plurality of frames in at least one second buffer. That is, the second buffer can temporarily hold frames that were not selected for the first buffer based on the ranking model. Additionally, the one or more processors can transfer at least one of the plurality of non-selected frames in the at least one second buffer to the at least one first buffer responsive to an update to the predetermined maximum number of frames (e.g., an increase in the buffer size or a change in ranking thresholds) or a detected relevance (e.g., a frame previously ranked low becomes relevant due to new data or context) of at least one of the plurality of non-selected frames. That is, frames in the second buffer can be re-evaluated for inclusion in the first buffer based on the updated criteria. For example, when a predetermined maximum number of frames is updated (e.g., from 100 to 120 frames), the processors can add additional frames from the second buffer that meet the updated criteria. For example, when a relevance is detected (e.g., from a change in event type or scene detected by a machine-learning model), the processors can promote a previously non-selected frame to the first buffer for retention.

The method 300, at block 340, includes providing, from the at least one first buffer, the first subset of frames (e.g., provide the select frames—the highest-ranked frames) as input to a first machine-learning model (e.g., video LLM trained and implemented to receive user queries). That is, the first subset of frames, now modeled for relevance and importance, can be fed into the machine-learning model for further processing. For example, the selected frames can be used to generate video summaries, answer queries, or perform additional analysis.

In some implementations, method 300 can further include determining a second subset of frames (e.g., perform a second pass) of the first subset of frames based on metadata of the first subset of frames. That is, the second subset of frames can be refined by re-evaluating the first subset with additional metadata or criteria. Additionally, method 300 can include updating the at least one first buffer based on the second subset of frames. For instance, frames in the first buffer can be replaced or re-ordered based on the second pass.

In some implementations, method 300 can further include receiving a query regarding content of the video stream. For instance, the query can be about the video stream, e.g., summarize the video. Additionally, method 300 can include generating, using the first machine-learning model, an output based on the first subset of frames, the output including a response to the query extracting video content of the video stream, wherein the first subset of frames represents the summarization of the video stream. For instance, the output can be a summary such as, “The video depicts a soccer match with two teams.” In some implementations, in response to receiving the query, method 300 can include determining a third subset of frames to apply to the first machine-learning model to generate the output based on detecting, using a second machine-learning model, one or more actions, objects, or movements described in the query. Determining can include selecting frames that correspond to specific actions or objects mentioned in the query. Detecting can include identifying those actions or objects using the second machine-learning model. That is, based on the text prompt, the one or more processors can extract information and use it in the selection of frames for analysis. For instance, if the query asks for goals in a soccer match, frames depicting those moments can be prioritized.

In some implementations, the video stream can be a live stream. In some implementations, the video stream can be an offline stream stored in a file. In some implementations, method 300 can further include configuring the at least one first buffer for the live stream or the offline stream to perform frame storage. For instance, the at least one first buffer can be configured to perform a circularity process on the first subset of frames stored in the at least one first buffer (e.g., overwrite old frames with new ones using a circular buffer). In another instance, the at least one first buffer can be configured to perform segmenting of the video stream into one or more segments, including a fourth subset of frames of the plurality of frames based on at least one segmentation parameter (e.g., divide the video stream into segments for modeling). In yet another instance, the at least one first buffer can be configured to apply storing (or store) a fifth subset of frames of the plurality of frames from a previous segment (e.g., retain from adjacent segments) of the one or more segments and updating the fifth subset of frames based on an updating parameter. That is, the one or more processors can adjust overlapping windows at a predetermined period of time to cover frames from both the preceding and following segments.

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some implementations, language models, such as large language models (LLMs), vision language models (VLMs), multi-modal language models (MMLMs), and/or other types of generative artificial intelligence (AI) can be implemented. These models can be capable of understanding, summarizing, translating, and/or otherwise generating text (e.g., natural language text, code, etc.), images, video, computer-aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large numbers of learnable network parameters (weights and biases)—such as millions or billions of parameters. The LLMs/VLMs/MMLMs/etc. can be implemented for summarizing textual data, analyzing and extracting insights from data (e.g., textual, image, video, etc.), and generating new text/image/video/etc. in user-specified styles, tones, and/or formats (e.g., summarizing video content using ranked frames, generating video summaries based on ranked segments). The LLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video (e.g., processing ranked video frames, generating outputs based on frame rankings). For example, vision language models (VLMs), or more generally multi-modal language models (MMLMs), can be implemented to accept image, video, audio, textual, 3D design (e.g., CAD), and/or other input data types and/or to generate or output image, video, audio, textual, 3D design, and/or other output data types (e.g., using ranked frames for video generation, applying frame selection criteria in generating video content).

Various types of LLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/VLMs/MMLMs/etc. architectures such as recurrent neural networks (RNNs) or long short-term memory networks (LSTMs) can be used, while in other implementations transformer architectures-such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/MMLMs/etc. can also include one or more diffusion block(s) (e.g., denoisers). The LLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/VLMs/MMLMs/etc.

In various implementations, the LLMs/VLMs/MMLMs/etc. can be trained using unsupervised learning, in which an LLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 4A is a block diagram of an example generative language model system 400 suitable for use in implementing at least some implementations of the present disclosure. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which can include an LLM, a VLM, a multi-modal LM, etc.).

At a high level, the input processor 405 can receive an input 401 including text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 430 (e.g., LLM/VLM/MMLM/etc.). In some implementations, the input 401 includes plain text in the form of one or more sentences, paragraphs, and/or documents. Additionally or alternatively, the input 401 can include numerical sequences, precomputed embeddings (e.g., word or sentence embeddings, frame embeddings, motion vector embeddings), and/or structured data (e.g., in tabular formats, JSON, or XML). In some implementations in which the generative LM 430 is capable of processing multi-modal inputs, the input 401 can combine text (or can omit text) with image data, audio data, video data, design data, USD data, and/or other types of input data (e.g., video frames with associated metadata, optical flow data, bitrate variation data). Taking raw input text as an example, the input processor 405 can prepare raw input text in various ways. For example, the input processor 405 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 can remove stopwords to reduce noise and focus the generative LM 430 on more meaningful content. The input processor 405 can apply text normalization, for example, by converting all characters to lowercase, removing accents, and/or handling special cases like contractions or abbreviations to ensure consistency. These are just a few examples, and other types of input processing can be applied (e.g., video frame normalization, frame ranking based on metadata or video parameters, segmenting video streams into analyzed portions).

In some implementations, a RAG component 492 (which can include one or more RAG models, and/or can be performed using the generative LM 430 itself) can be used to retrieve additional information to be used as part of the input 401 or prompt. RAG can be used to enhance the input to the LLM/VLM/MMLM/etc. with external knowledge, so that answers to specific questions or queries or requests are more relevant—such as in a case where specific knowledge is required. The RAG component 492 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 401 can be generated using the query or input to the model (e.g., a question, a request, etc.) in addition to data retrieved using the RAG component 492. In some implementations, the input processor 405 can analyze the input 401 and communicate with the RAG component 492 (or the RAG component 492 can be part of the input processor 405, in implementations) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 can retrieve a prior stored conversation history—or at least a summary thereof—and include the prior conversation history along with the current ask/request as part of the input 401 to the generative LM 430.

The RAG component 492 can use various RAG techniques. For example, naive RAG can be used where documents are indexed, chunked, and applied to an embedding model to generate embeddings corresponding to the chunks. A user query can also be applied to the embedding model and/or another embedding model of the RAG component 492 and the embeddings of the chunks along with the embeddings of the query can be compared to identify the most similar/related embeddings to the query, which can be supplied to the generative LM 430 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 492 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 410 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy can depend on factors such as the language being processed, the task at hand, and/or characteristics of the training dataset. As such, the tokenizer 410 can convert the (e.g., processed) text into a structured format according to tokenization schema being implemented in the particular implementation.

The embedding component 420 can use any known embedding technique to transform discrete tokens into (e.g., dense, continuous vector) representations of semantic meaning. For example, the embedding component 420 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 can resize the data to a standard size compatible with format of a corresponding input channel and/or can normalize pixel values to a common range (e.g., 0 to 1) to ensure a consistent representation, and the embedding component 420 can encode the image data using any known technique (e.g., using one or more convolutional neural networks (CNNs) to extract visual features). In some implementations in which the input 401 includes audio data, the input processor 401 can resample an audio file to a consistent sampling rate for uniform processing, and the embedding component 420 can use any known technique to extract and encode audio features—such as in the form of a spectrogram (e.g., a mel-spectrogram). In some implementations in which the input 401 includes video data, the input processor 401 can extract frames or apply resizing to extracted frames, and the embedding component 420 can extract features such as optical flow embeddings or video embeddings and/or can encode temporal information or sequences of frames. In some implementations in which the input 401 includes multi-modal data, the embedding component 420 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 can apply an encoded representation of the input 401 to the generative LM 430, and the generative LM 430 can process the encoded representation of the input 401 to generate an output 490, which can include responsive text and/or other types of data.

As described herein, in some implementations, the generative LM 430 can be configured to access or use-or capable of accessing or using-plug-ins/APIs 495 (which can include one or more plug-ins, application programming interfaces (APIs), databases, data stores, repositories, etc.). For example, for certain tasks or operations that the generative LM 430 is not ideally suited for, the model can have instructions (e.g., as a result of training, and/or based on instructions in a given prompt, such as those retrieved using the RAG component 492) to access one or more plug-ins/APIs 495 (e.g., 3rd party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 495 to the plug-in/API 495, the plug-in/API 495 can process the information and return an answer to the generative LM 430, and the generative LM 430 can use the response to generate the output 490. This process can be repeated—e.g., recursively—for any number of iterations and using any number of plug-ins/APIs 495 until an output 490 that addresses each ask/question/request/process/operation/etc. from the input 401 can be generated. As such, the model(s) can not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example implementation in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 4A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 435 of the generative LM 430 (e.g., embeddings of video frames ranked based on motion vectors, IDR frames, scene changes, bitrate variation, or optical flow data).

In an example implementation, the encoder(s) 435 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices (e.g., weights assigned based on ranking criteria such as motion vector intensity, scene transitions, and metadata significance). Any number of encoders can be cascaded to generate a context vector encoding the input (e.g., the ranked and selected frames or textual data related to video content). An attention projection layer 440 can convert the context vector into attention vectors (keys and values) for the decoder(s) 445 (e.g., for further processing of video frames based on ranking and selection criteria).

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 can generate a first token, and the generation mechanism 455 can apply the generated token as an input during a second pass. The process can repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 can output some decoded (e.g., vector) representation of the input being applied during a particular pass. The classifier 450 can include a multi-class classifier including one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 can select or sample a word or token based on a corresponding predicted probability (e.g., select the word with the highest predicted probability) and append it to the output from a previous pass, generating each word or token sequentially. The generation mechanism 455 can repeat the process, triggering successive decoder inputs and corresponding predictions until selecting or sampling a symbol or token that represents the end of the response, at which point, the generation mechanism 455 can output the generated response.

FIG. 4C is a block diagram of an example implementation in which the generative LM 430 includes a decoder-only transformer architecture. For example, the decoder(s) 460 of FIG. 4C can operate similarly as the decoder(s) 445 of FIG. 4B except each of the decoder(s) 460 of FIG. 4C omits the encoder-decoder self-attention layer (since there is no encoder in this implementation). As such, the decoder(s) 460 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., frames ranked by relevance, video parameters with associated weights, metadata-based rankings) can be applied to the decoder(s) 460. As with the decoder(s) 445 of FIG. 4B, each token (e.g., word) can flow through a separate path in the decoder(s) 460, and the decoder(s) 460, a classifier 465, and a generation mechanism 470 can use auto-regression to sequentially generate one token at a time until predicting a symbol or token that represents the end of the response (e.g., end of ranked frame sequence, completion of frame management process, final selected frame for summarization). The classifier 465 and the generation mechanism 470 can operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 5 is a block diagram of an example computing device(s) 500 suitable for use in implementing some implementations of the present disclosure. Computing device 500 can include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 can include one or more virtual machines (VMs), and/or any of the components thereof can include virtual components (e.g., virtual hardware components). For non-limiting examples, one or more of the GPUs 508 can include one or more vGPUs, one or more of the CPUs 506 can include one or more vCPUs, and/or one or more of the logic units 520 can include one or more virtual logic units. As such, a computing device(s) 500 can include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, can be considered an I/O component 514 (e.g., if the display is a touch screen). As another example, the CPUs 506 and/or GPUs 508 can include memory (e.g., the memory 504 can be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 can represent one or more links or busses, such as an address bus, a data bus, a control bus, or a combination thereof. The interconnect system 502 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 can be directly connected to the memory 504. Further, the CPU 506 can be directly connected to the GPU 508. Where there is direct, or point-to-point connection between components, the interconnect system 502 can include a PCIe link to carry out the connection. In these examples, a PCI bus need not be included in the computing device 500.

The memory 504 can include any of a variety of computer-readable media. The computer-readable media can be any available media that can be accessed by the computing device 500. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 504 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 506 can be configured to execute at least some of the computer-readable instructions to control one or more components of the computing device 500 to perform one or more of the methods and/or processes described herein. The CPU(s) 506 can each include one or more cores (e.g., one, two, four, eight, twenty-eight, seventy-two, etc.) that are capable of handling a multitude of software threads simultaneously. The CPU(s) 506 can include any type of processor, and can include different types of processors depending on the type of computing device 500 implemented (e.g., processors with fewer cores for mobile devices and processors with more cores for servers). For example, depending on the type of computing device 500, the processor can be an Advanced RISC Machines (ARM) processor implemented using Reduced Instruction Set Computing (RISC) or an x86 processor implemented using Complex Instruction Set Computing (CISC). The computing device 500 can include one or more CPUs 506 in addition to one or more microprocessors or supplementary co-processors, such as math co-processors.

In addition to or alternatively from the CPU(s) 506, the GPU(s) 508 can be configured to execute at least some of the computer-readable instructions to control one or more components of the computing device 500 to perform one or more of the methods and/or processes described herein. One or more of the GPU(s) 508 can be an integrated GPU (e.g., with one or more of the CPU(s) 506 and/or one or more of the GPU(s) 508 can be a discrete GPU. In implementations, one or more of the GPU(s) 508 can be a coprocessor of one or more of the CPU(s) 506. The GPU(s) 508 can be used by the computing device 500 to render graphics (e.g., 3D graphics) or perform general purpose computations. For example, the GPU(s) 508 can be used for General-Purpose computing on GPUs (GPGPU). The GPU(s) 508 can include hundreds or thousands of cores that are capable of handling hundreds or thousands of software threads simultaneously. The GPU(s) 508 can generate pixel data for output images in response to rendering commands (e.g., rendering commands from the CPU(s) 506 received via a host interface). The GPU(s) 508 can include graphics memory, such as display memory, for storing pixel data or any other suitable data, such as GPGPU data. The display memory can be included as part of the memory 504. The GPU(s) 508 can include two or more GPUs operating in parallel (e.g., via a link). The link can directly connect the GPUs (e.g., using NVLINK) or can connect the GPUs through a switch (e.g., using NVSwitch). When combined together, each GPU 508 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 506 and/or the GPU(s) 508, the logic unit(s) 520 can be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 can discretely or jointly perform any combination of the methods, processes and/or portions thereof. One or more of the logic units 520 can be part of and/or integrated in one or more of the CPU(s) 506 and/or the GPU(s) 508 and/or one or more of the logic units 520 can be discrete components or otherwise external to the CPU(s) 506 and/or the GPU(s) 508. In implementations, one or more of the logic units 520 can be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 can include one or more receivers, transmitters, and/or transceivers that allow the computing device 500 to communicate with other computing devices via an electronic communication network, included wired and/or wireless communications. The communication interface 510 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 520 and/or communication interface 510 can include one or more data processing units (DPUs) to transmit data received over a network and/or through interconnect system 502 directly to (e.g., a memory of) one or more GPU(s) 508.

The I/O ports 512 can allow the computing device 500 to be logically coupled to other devices including the I/O components 514, the presentation component(s) 518, and/or other components, some of which can be built in to (e.g., integrated in) the computing device 500. Illustrative I/O components 514 include a microphone, mouse, keyboard, joystick, game pad, game controller, satellite dish, scanner, printer, wireless device, etc. The I/O components 514 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 can be include depth cameras, such as stereoscopic camera systems, infrared camera systems, RGB camera systems, touchscreen technology, and combinations of these, for gesture detection and recognition. Additionally, the computing device 500 can include accelerometers or gyroscopes (e.g., as part of an inertia measurement unit (IMU)) that allow detection of motion. In some examples, the output of the accelerometers or gyroscopes can be used by the computing device 500 to render immersive augmented reality or virtual reality.

The power supply 516 can include a hard-wired power supply, a battery power supply, or a combination thereof. The power supply 516 can provide power to the computing device 500 to allow the components of the computing device 500 to operate.

The presentation component(s) 518 can include a display (e.g., a monitor, a touch screen, a television screen, a heads-up-display (HUD), other display types, or a combination thereof), speakers, and/or other presentation components. The presentation component(s) 518 can receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that can be used in at least one implementation of the present disclosure. The data center 600 can include a data center infrastructure layer 610, a framework layer 620, a software layer 630, and/or an application layer 640.

As shown in FIG. 6, the data center infrastructure layer 610 can include a resource orchestrator 612, grouped computing resources 614, and node computing resources (“node C.R.s”) 616(1)-616(N), where “N” represents any whole, positive integer. In at least one implementation, node C.R.s 616(1)-616(N) can include, but are not limited to, any number of central processing units (CPUs) or other processors (including DPUs, accelerators, field-programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. (e.g., for processing video frames, managing ranked frame data, executing machine-learning models). In some implementations, one or more node C.R.s from among node C.R.s 616(1)-616(N) can correspond to a server having one or more of the above-mentioned computing resources (e.g., for implementing frame ranking algorithms, managing frame buffers). In addition, in some implementations, the node C.R.s 616(1)-6161(N) can include one or more virtual components, such as vGPUs, vCPUs, and/or the like, and/or one or more of the node C.R.s 616(1)-616(N) can correspond to a virtual machine (VM) (e.g., for simulating video processing tasks, optimizing ranking model performance).

In at least one implementation, grouped computing resources 614 can include separate groupings of node C.R.s 616 housed within one or more racks (not shown), or many racks housed in data centers at various geographical locations (also not shown). Separate groupings of node C.R.s 616 within grouped computing resources 614 can include grouped compute, network, memory, or storage resources that can be configured or allocated to support one or more workloads (e.g., processing high-volume video streams, ranking and storing frames in real-time). In at least one implementation, several node C.R.s 616 including CPUs, GPUs, DPUs, and/or other processors can be grouped within one or more racks to provide compute resources to support one or more workloads (e.g., parallel processing of video parameters, managing distributed ranking operations). The one or more racks can also include any number of power modules, cooling modules, and/or network switches, in any combination.

The resource orchestrator 612 can configure or otherwise control one or more node C.R.s 616(1)-616(N) and/or grouped computing resources 614. In at least one implementation, resource orchestrator 612 can include a software design infrastructure (SDI) management entity for the data center 600. The resource orchestrator 612 can include hardware, software, or some combination thereof.

In at least one implementation, as shown in FIG. 6, framework layer 620 can include a job scheduler 628, a configuration manager 634, a resource manager 636, and/or a distributed file system 638. The framework layer 620 can include a framework to support software 632 of software layer 630 and/or one or more application(s) 642 of application layer 640. The software 632 or application(s) 642 can respectively include web-based service software or applications, such as those provided by Amazon Web Services, Google Cloud and Microsoft Azure. The framework layer 620 can be, but is not limited to, a type of free and open-source software web application framework such as Apache Spark™ (hereinafter “Spark”) that can use distributed file system 638 for large-scale data processing (e.g., “big data”). In at least one implementation, job scheduler 628 can include a Spark driver to facilitate scheduling of workloads supported by various layers of data center 600. The configuration manager 634 can be capable of configuring different layers such as software layer 630 and framework layer 620 including Spark and distributed file system 638 for supporting large-scale data processing. The resource manager 636 can be capable of managing clustered or grouped computing resources mapped to or allocated for support of distributed file system 638 and job scheduler 628. In at least one implementation, clustered or grouped computing resources can include grouped computing resource 614 at data center infrastructure layer 610. The resource manager 636 can coordinate with resource orchestrator 612 to manage these mapped or allocated computing resources.

In at least one implementation, software 632 included in software layer 630 can include software used by at least portions of node C.R.s 616(1)-616(N), grouped computing resources 614, and/or distributed file system 638 of framework layer 620. One or more types of software can include, but are not limited to, Internet web page search software, e-mail virus scan software, database software, and streaming video content software.

In at least one implementation, application(s) 642 included in application layer 640 can include one or more types of applications used by at least portions of node C.R.s 616(1)-616(N), grouped computing resources 614, and/or distributed file system 638 of framework layer 620. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 634, resource manager 636, and resource orchestrator 612 can implement any number and type of self-modifying actions based on any amount and type of data acquired in any technically feasible fashion. Self-modifying actions can relieve a data center operator of data center 600 from making possibly bad configuration decisions and possibly avoiding underutilized and/or poor performing portions of a data center.

The data center 600 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 600. In at least one implementation, trained or deployed machine learning models corresponding to one or more neural networks can be used to infer or predict information using resources described above with respect to the data center 600 by using weight parameters calculated through one or more training techniques, such as but not limited to those described herein.

In at least one implementation, the data center 600 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 500 of FIG. 5—e.g., each device can include similar components, features, and/or functionality of the computing device(s) 500. In addition, where backend devices (e.g., servers, NAS, etc.) are implemented, the backend devices can be included as part of a data center 600, an example of which is described in more detail herein with respect to FIG. 6.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 500 described herein with respect to FIG. 5. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
receive a plurality of frames and metadata from a capture device capturing a video stream;
generate, using a ranking model, a plurality of rankings for the plurality of frames based on a plurality of video parameters of the plurality of frames and the metadata of the video stream, wherein the plurality of rankings correspond to a summarization of the video stream;
determine at least one of the plurality of frames to provide to at least one first buffer based on the plurality of rankings, wherein the at least one first buffer stores a first subset of frames of the plurality of frames; and
provide, from the at least one first buffer, the first subset of frames as input to a first machine-learning model.

2. The one or more processors of claim 1, wherein the one or more circuits are to:
determine a second subset of frames of the first subset of frames based on metadata of the first subset of frames; and
update the at least one first buffer based on the second subset of frames.

3. The one or more processors of claim 1, wherein the one or more circuits are to:
receive a query regarding content of the video stream; and
generate, using the first machine-learning model, an output based on the first subset of frames, the output comprising a response to the query extracting video content of the video stream, wherein the first subset of frames represent the summarization of the video stream.

4. The one or more processors of claim 3, wherein the one or more circuits are to:
in response to receiving the query, determine a third subset of frames to apply to the first machine-learning model to generate the output based on detecting, using a second machine-learning model, one or more actions, objects, or movements described in the query; and
wherein the summarization represented in the plurality of rankings correspond to the determination of the first subset of frames representing one or more temporal or spatial segments of the video stream.

5. The one or more processors of claim 1, wherein:
generating, using the ranking model, the plurality of rankings further comprises applying differential weighting to the plurality of video parameters; and
at least one first video parameter is assigned a higher weight according to the ranking model than at least one second video parameter based on the metadata of the plurality of frames.

6. The one or more processors of claim 1, wherein the one or more circuits are to:
receive an encoded bitstream of the video stream; and
decode the encoded bitstream to extract the plurality of frames, the plurality of video parameters, and the metadata of the video stream.

7. The one or more processors of claim 6, wherein the plurality of video parameters comprise at least one of:
one or more motion vectors obtained from the encoded bitstream, the one or more motion vectors corresponding to movement data of one or more objects in the plurality of frames;
instantaneous decoder refresh (IDR) frames or scene change indicators obtained from the encoded bitstream, the IDR frames or scene change indicators corresponding to content updates in the plurality of frames;
one or more bitrate variations obtained from the encoded bitstream, the one or more bitrate variations corresponding to data rate updates used to encode the video stream; or
one or more optical flow motion vectors obtained from the encoded bitstream, the one or more optical flow motion vectors corresponding to movement data of one or more objects in consecutive frames of the plurality of frames.

8. The one or more processors of claim 1, wherein generating the plurality of rankings is further based on using a one or more computer vision (CV) models to perform at least one of:
detecting one or more actions or movements within the plurality of frames to increase an efficiency metric of the ranking model;
detecting and tracking one or more objects within the plurality of frames to generate the plurality of rankings using the ranking model further based on prioritizing a first type of object of the one or more objects over a second type of object of the one or more objects; or
identifying one or more areas of the plurality of frames to detect activity to generate the plurality of rankings using the ranking model further based on prioritizing a first area of the plurality of frames over a second area of the plurality of frames.

9. The one or more processors of claim 1, wherein:
the metadata of video stream comprises text data of the video stream and of text data of content within the plurality of frames, the text data of the video stream and of the content comprises at least a type of video and an event type being videoed.

10. The one or more processors of claim 1, wherein:
the first subset of frames is further determined based on a plurality of similarity metrics of the plurality of frames, wherein the plurality of similarity metrics are determined using at least one of (i) a cosine distance, (ii) a Siamese network, (iii) a structural similarity, or (iv) background subtraction; and
the first subset of frames is further determined based on a minimum distance metric between the plurality of frames.

11. The one or more processors of claim 1, wherein the one or more circuits are to:
maintain the at least one first buffer containing a predetermined maximum number of frames based on the plurality of rankings.

12. The one or more processors of claim 11, wherein the one or more circuits are to:
store a plurality of non-selected frames from the plurality of frames in at least one second buffer; and
transfer at least one of the plurality of non-selected frames in the at least one second buffer to the at least one first buffer responsive to an update to the predetermined maximum number of frames or a detected relevance of at least one of the plurality of non-selected frames.

13. The one or more processors of claim 1, wherein the video stream is at least one of a live stream or an offline stream stored in a file, and wherein the one or more circuits are to:
configure the at least one first buffer for the live stream or the offline stream to perform frame storage, wherein the at least one first buffer is configured to perform at least one of:
(i) a circularity process on the first subset of frames stored in the at least one first buffer,
(ii) segmenting of the video stream into one or more segments comprising a fourth subset of frames of the plurality of frames based on at least one segmentation parameter, or
(iii) storing a fifth subset of frames of the plurality of frames from a previous segment of the one or more segments and updating the fifth subset of frames based on an updating parameter.

14. The system of claim 1, wherein the plurality of processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing vision language models (VLMs);
a system implementing large language models (LLMs);
a system implementing multi-modal language models;
a system for hosting one or more real-time streaming applications;
a system for performing light transport simulation;
a system for performing collaborative content creation for 3D assets; or
a system implemented at least partially using cloud computing resources.

15. A system, comprising:
one or more processors to execute operations comprising:
receive a plurality of frames and metadata from a capture device capturing a video stream;
generate, using a ranking model, a plurality of rankings for the plurality of frames based on a plurality of video parameters of the plurality of frames and the metadata of the video stream, wherein the plurality of rankings correspond to a summarization of the video stream;
determine at least one of the plurality of frames to provide to at least one first buffer based on the plurality of rankings, wherein the at least one first buffer stores a first subset of frames of the plurality of frames; and
provide, from the at least one first buffer, the first subset of frames as input to a first machine-learning model.

16. The system of claim 15, the one or more processors executing the operations are to:
determine a second subset of frames of the first subset of frames based on metadata of the first subset of frames; and
update the at least one first buffer based on the second subset of frames.

17. The system of claim 15, the one or more processors executing the operations are to:
receive a query regarding content of the video stream; and
generate, using the first machine-learning model, an output based on the first subset of frames, the output comprising a response to the query extracting video content of the video stream, wherein the first subset of frames represent the summarization of the video stream;
in response to receiving the query, determine a third subset of frames to apply to the first machine-learning model to generate the output based on detecting, using a second machine-learning model, one or more actions, objects, or movements described in the query; and
wherein the summarization represented in the plurality of rankings correspond to the determination of the first subset of frames representing one or more temporal or spatial segments of the video stream.

18. The system of claim 15, wherein:
generating, using the ranking model, the plurality of rankings further comprises applying differential weighting to the plurality of video parameters; and
at least one first video parameter is assigned a higher weight according to the ranking model than at least one second video parameter based on the metadata of the plurality of frames.

19. The system of claim 15, the one or more processors executing the operations are to:
receive an encoded bitstream of the video stream;
decode the encoded bitstream to extract the plurality of frames, the plurality of video parameters, and the metadata of the video stream;
wherein the plurality of video parameters comprise at least one of:
one or more motion vectors obtained from the encoded bitstream, the one or more motion vectors corresponding to movement data of one or more objects in the plurality of frames;
instantaneous decoder refresh (IDR) frames or scene change indicators obtained from the encoded bitstream, the IDR frames or scene change indicators corresponding to content updates in the plurality of frames;
one or more bitrate variations obtained from the encoded bitstream, the one or more bitrate variations corresponding to data rate updates used to encode the video stream; or
one or more optical flow motion vectors obtained from the encoded bitstream, the one or more optical flow motion vectors corresponding to movement data of one or more objects in consecutive frames of the plurality of frames.

20. A method, comprising:
receiving, using one or more processors, a plurality of frames and metadata from a capture device capturing a video stream;
generating, using the one or more processors performing a ranking model, a plurality of rankings for the plurality of frames based on a plurality of video parameters of the plurality of frames and the metadata of the video stream, wherein the plurality of rankings correspond to a summarization of the video stream;
determining, using the one or more processors, at least one of the plurality of frames to provide to at least one first buffer based on the plurality of rankings, wherein the at least one first buffer stores a first subset of frames of the plurality of frames; and
providing, using the one or more processors from the at least one first buffer, the first subset of frames as input to a first machine-learning model.
